(19) United States
(12) Patent Application Publication
(10) Pub. No.: US 2012/0040650 A1
(43) Pub. Date: Feb. 16, 2012

(54) SYSTEM FOR AUTOMATED DETECTION OF MOBILE PHONE USAGE

(76) Inventor: Michael Rosen, Akron, OH (US)

(21) Appl. No.: 13/277,990

(22) Filed: Oct. 20, 2011

Related U.S. Application Data
(63) Continuation-in-part of application No. 12/685,454, filed on Jan. 11, 2010.
Application No. 12/685,454 is a continuation-in-part of application No. 11/678,489, filed on Feb. 23, 2007, now Pat. No. 7,646,312.
Application No. 12/685,454 is a continuation-in-part of application No. 12/433,219, filed on Apr. 30, 2009.
(60) Provisional application No. 60/837,594, filed on Aug. 11, 2006.
(60) Provisional application No. 61/049,610, filed on May 1, 2008.
(60) Provisional application No. 61/175,952, filed on May 6, 2009.
(60) Provisional application No. 61/487,694, filed on May 18, 2011.

(51) Int. Cl. H04W 4/00; H04W 24/00

(52) U.S. Cl. 455/414.1

(57) ABSTRACT

A method and apparatus for automated detection of mobile phone usage includes a detection system operative to detect a mobile phone signal transmitted from a mobile phone from a building or other location. Responsive to the detection, the detection system is operative communicate data representative of the detection to a monitoring system. The monitoring system is operative to determine the location of the detection system and cause an output device to output information indicative of the detection and the location of the detection to a user.

### CROSS REFERENCE TO RELATED APPLICATIONS

This application is a continuation-in-part application of U.S. application Ser. No. 12/685,454 filed Jan. 11, 2010 and this application claims benefit pursuant to 35 U.S.C. §119(e) of U.S. Provisional Application No. 61/487,694 filed May 18, 2011. U.S. application Ser. No. 12/685,454 is a continuation-in-part application of U.S. application Ser. No. 11/678,489 filed Feb. 23, 2007 (now U.S. Pat. No. 7,646,312), which application claims the benefit pursuant to 35 U.S.C. §119(e) of U.S. Provisional Application No. 60/837,594 filed on Aug. 11, 2006. U.S. application Ser. No. 12/685,454 is also a continuation-in-part application of U.S. application Ser. No. 12/433,219 filed Apr. 30, 2009, which application claims the benefit pursuant to 35 U.S.C. §119(e) of U.S. Provisional Application No. 61/049,610 filed May 1, 2008. In addition, U.S. application Ser. No. 12/685,454 claims the benefit pursuant to 35 U.S.C. §119(e) of U.S. Provisional Application Ser. No. 61/175,952 filed May 6, 2009. All of these applications are hereby incorporated herein by reference in their entirety.

### BACKGROUND

As mobile telephones (“mobile phones”) have come into widespread use, people often use their mobile phones while driving vehicles. However, mobile phone usage by the driver of a vehicle can significantly distract the driver's attention from driving-related tasks. As result, mobile phone use while driving can significantly increase the risk of traffic violations and driving accidents. Accordingly, it is desirable to provide a system and method which is operative to assist in decreasing traffic violations and driving accidents caused by mobile phone use while driving. It may also be desirable to provide other improvements involving mobile phone usage.

### DISCLOSURE OF INVENTION

It is an aspect of at least one embodiment to provide a system and method which is operative to assist in decreasing traffic violations and driving accidents caused by mobile phone use while driving.

Further aspects of embodiments will be made apparent in the following Best Modes for Carrying Out Invention and the appended claims.

The foregoing aspects may be accomplished in at least one embodiment by an apparatus and method operative to detect mobile phone signals (which may include cell phone signals as well any other wireless signal with which a mobile phone may communicate). In an example embodiment, a method may comprise a step in which a detection system detects, through operation of at least one processor, at least one mobile phone signal (e.g., through use of a mobile phone signal receiver device). This described example method may also comprise a step of determining, through operation of the at least one processor, that the detected at least one mobile phone signal originated from a predetermined location. For example, the processor may be configured to determine that the detected signal has characteristics such as sufficiently high signal strength, duration, source movement and/or other characteristics which indicate that it originates from a particular predetermined location near one or more antenna of the mobile phone signal receiver device. Also, the processor may be configured to evaluate the detected mobile phone signal to determine that the detected signal corresponds to an ongoing voice communication, Internet access, or other human-involved activity with the mobile phone generating the detected mobile phone signal.

In addition, in this described example, the method may include a step of sending information, through operation of the at least one processor, to at least one remote server, which information includes data representative of the detection of the at least one mobile phone signal originating from the predetermined location.

In this described method, the predetermined location, for example, may include at least one of a vehicle (e.g., inside the vehicle), a portion of a roadway (through which vehicles pass) that is adjacent the detection system, and a room in a building (e.g., a prison cell, hospital room, casino, courtroom), or any other predetermined location at which mobile phone signals may be detected as originating therefrom.

In some embodiments, the method may include emitting radiation such as non-visible radiation (e.g., light such as infrared light that is not visible or is at least substantially not visible to human eyes) toward the predetermined location from at least one radiation transmitter device (e.g., an infrared light illuminator). In this described embodiment, the method may include receiving portions of the radiation with at least one radiation receiver device after the portions of the radiation have reflected off of matter inside and outside a vehicle. Such a radiation receiver device may correspond to one or more image capture devices such as a still camera or a video camera capable of capturing light such as infrared light and/or visible light.

In addition, the method may include generating at least one digital image including a visual representation of at least portions of the matter inside the vehicle responsive to the received portions of the radiation. Also, in this described method, the information that includes data representative of the detection may include at least one digital image that depicts at least portions of the matter inside the vehicle, such as the occupants of the vehicle and/or an image of a driver or other occupant holding a mobile phone.

In an example embodiment, one or more radiation receiver devices (such as cameras) may be positioned to view a license plate of the vehicle while in the predetermined location. Thus, in this embodiment, the method may include receiving further portions of the radiation (such as visible and/or infrared light) with the at least one radiation receiver device after the further portions of the radiation have reflected off of a license plate of the vehicle. Also this embodiment may include generating at least one digital image depicting the license plate responsive to the received further portions of the radiation. In addition, in this embodiment, the information sent to the at least one computer may include the at least one digital image that depicts the license plate.

In further example embodiments, the method may include carrying out, through operation of at least one processor, facial recognition of at least one face depicted in the at least one digital image to determine data identify a person. Also, in further example embodiments, the method may include determining, through operation of at least one processor, at least one characteristic regarding the vehicle depicted in the at least one digital image. Such determined characteristics may include for example, a make of the vehicle, a model of the vehicle, a type of the vehicle, and a color of the vehicle. Also, in further example embodiments, the method may include determining, through operation of the at least one processor, velocity of the vehicle, responsive to a plurality of digital images generated responsive to the radiation received with the at least one radiation receiver device.

In addition, in an example embodiment the method may include, verifying, through operation of the at least one processor, that the at least one digital image captured an image of the vehicle in the predetermined location at the time when the mobile phone signal was received by the mobile phone signal receiver device from a position originating from the predetermined location.

In an example embodiment of the method, the information sent to the remote server may include data usable by the remote server to determine the predetermined location from which the mobile phone signal was detected as originating. For example, in an embodiment where the method is carried out to detect mobile phone usage in vehicles along a roadway (i.e., the predetermined location is a roadway adjacent the detection system), the detection system carrying out the method may be movable along the roadway by being mounted to a moving vehicle such as a bus, truck, police vehicle, or any other type of moving vehicle. In such an example, the data sent to the remote server may include a geographical location determined via a global positioning system (e.g., a street address, roadway description, map coordinates and/or, other location data) corresponding to the location for which the system detected a vehicle using a mobile phone adjacent the vehicle that includes the system. In this example, the detection system mounted to the moving vehicle may capture images of the vehicles adjacent thereto, including the license plates of the adjacent vehicles. Also the system mounted may detect mobile phone signals originating from the adjacent vehicle.

In addition, in embodiments where the detection system is mounted in vehicle to detect usage of a mobile phone in the vehicle (i.e., the predetermined location is in a particular vehicle), the data sent to the remote computer may include an identification for the vehicle or the person owning the vehicle, or other information usable to identify in which vehicle the mobile phone signal detection system is mounted.

In addition, in embodiments where the detection system is mounted in a building (i.e., the predetermined location is in a particular room such as a prison cell), the data sent to the remote computer may include a room number, location, or other identification which is usable to identity which room the mobile phone signal detection system sending the information is configured to monitor.

In an example embodiments where the detection system is mounted inside a vehicle, an example method may include determining, through operation of the at least one processor, a velocity of the vehicle (e.g., using a GPS). Responsive to the determined velocity, the processor may determine whether or not the vehicle was moving during the detection of the mobile phone signal in the vehicle. In some example embodiments, the method may include sending or storing the information regarding the detection of the mobile phone signal only for detections of mobile phone signals while the vehicle is moving or is moving at a speed above a configured threshold. In this described embodiment, the method may include sending the information from the vehicle through a wireless network (e.g., a cell phone network, IEEE 802.11a,b,g,n network, or other wireless network, using a wireless network interface device in operative connection with the described at least one processor.)

For example, in an example embodiment in which the wireless network interface device corresponds to an IEEE 802.11a,b,g,n communication device, a method may include storing the detection of the mobile signal event, the time of the detection, the velocity of the vehicle, GPS data, and or other detected data in a local data store. Then when the vehicle returns to a garage, parking lot or other location with a compatible wireless network, the method may at that time include uploading the data stored in the data store to the remote server. In addition, or alternatively, when the vehicle comes into range of a compatible wireless network, the method may include receiving, through operation of the at least one processor, a wireless signal through the wireless network interface device, which wireless signal is indicative of a request to cause or enable the at least one processor to send through the wireless network the information from the data store that includes data representative of the detection of the at least one mobile phone signal.

In example embodiments where the detection system is mounted in a vehicle to detect use of a mobile phone in the same vehicle, an example method may include causing an output of an audible output in the vehicle responsive to the detection of use of a mobile phone in the vehicle. Such an audible output may include an alarm or warning signal output from a speaker or other sound generating device in the system. Such an audible output may also be produced by causing the mobile phone itself to output the audible output during a call (e.g., via the system outputting an interruption signal such as a blocking signal that causes noise, static, other sounds, or silence in the audio output of the mobile phone call). In further embodiments, the audible output may correspond to or include a subliminal message which encourages the user to end the mobile phone call.

In example embodiments where the detection system is mounted in a vehicle, an example method may include providing electrical power to the system by transmitting a radio frequency signal from a radio frequency power transmitter device mounted in the vehicle remote from the detection system. The method may further include acquiring the electrical power by the detection system using a radio frequency power receiver device operative to receive the transmitted radio frequency signals. Such acquired electrical power may be stored by the detection system in a rechargeable battery for use when needed by other electrical components in the system such as the previously described processor and mobile phone signal detection system.

The previously described embodiments have been described with respect to different features and steps that may be included in the described methods or may be included in detection systems that carry out the described methods. However, it is to be understood that the described features and steps may be combined in different combinations depending on the desired functionality of an implementation of the described systems and methods.

### BRIEF DESCRIPTION OF DRAWINGS

FIG. 1 is a flowchart of a method of detecting and prosecuting for illegal use of a mobile phone by a driver.

FIG. 2 is a flowchart as in FIG. 1 additionally including a sensor device operative to detect the velocity of a vehicle that is above a speed limit.

FIG. 3 is a flowchart as in FIG. 1 in which image acquisition is enabled by detection of a mobile phone transmission and is triggered by a sensor such as a vehicle presence detection device.

FIG. 4 illustrates an embodiment of a detection system including a mobile phone signal receiver device and an image capture device.

FIG. 5 illustrates the detection system of FIG. 4, further including a sensor device for measuring the speed of the vehicle.

FIG. 6 illustrates the detection system of FIG. 4 in which signal detection enables or arms the system and a trigger causes image acquisition.

FIG. 7 illustrates a detection system which uses triangulation involving multiple antennas.

FIGS. 8 and 9 illustrate an example detection system that includes an infrared illumination device.

FIGS. 10-15 illustrate digital images captured with and without infrared illumination devices.

FIG. 16 illustrates an example detection system and various optional features of the system.

FIG. 17 illustrates an example detection system mounted in a vehicle that is operative to notify third parties of the use of a mobile phone in the vehicle.

FIG. 18 illustrates an example of a plurality of detection systems mounted in a building such as a prison.

### BEST MODES FOR CARRYING OUT INVENTION

Cellular (“cell”) telephones are mobile phones which are capable of receiving and making telephone calls wirelessly within a cellular network. Mobile phones may also be capable of sending and/or receiving other content, such as text messages, e-mails, web pages, music, video and other information. Other types of mobile phones include satellite phones which are capable of receiving and making telephone calls wirelessly using one or more orbiting satellites. Also, other types of mobile phones may be capable of sending and receiving communications using wireless networking technology such as IEEE 802.11a,b,g,n wireless communications.

Mobile phones may be packaged as handheld devices. Mobile phones may also be integrated into a vehicle or coupled to a vehicle or the driver, such that a driver may make and receive mobile phone calls without holding a portable device. Such devices are often referred to as “hands-free” phones and may include mobile phones integrated into the vehicle, mobile phones connected to the vehicle via wireless technology (e.g., Bluetooth), mobile phones operated remotely through voice commands, and/or mobile phones operated using a headset. As used herein, a mobile phone includes any communication device capable of being used to carry out wireless phone calls, text messages, web browsing and other communications while driving a vehicle. For example, as used herein a mobile phone may include communication devices such as laptop computers, PDAs, netbooks, tablets, portable gaming devices, or any other type of device which is capable of communication wirelessly from inside a vehicle.

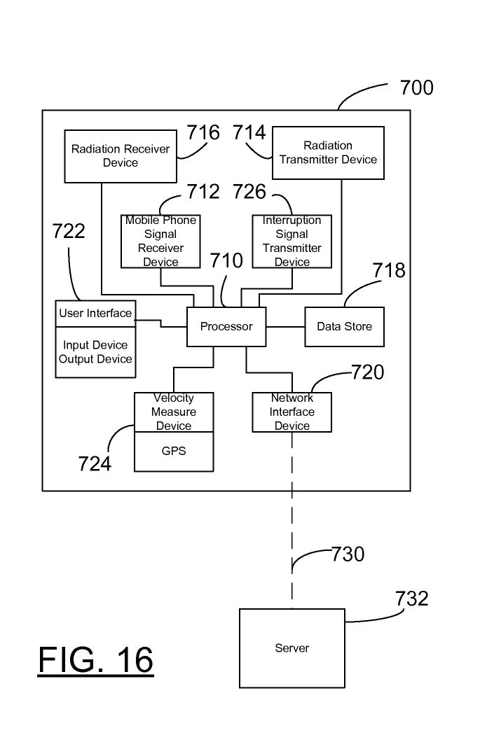

FIG. 16 illustrates an example detection system 700 that is operative to carry out the methods described herein related to detecting mobile phone use in vehicles and other locations. As shown in FIG. 16, the detection system may include at least one processor 710. The processor may include software and/or firmware operative to cause the processor to operate one or more of the devices included in the system and to carry out the determinations, functions, and calculations described herein. Such devices may include a mobile phone signal receiver device 712, which as described below in more detail is operative to use one or more antennas to receive mobile phone signals from a mobile phone in a predetermined location. The at least one processor 710 may be operatively programmed to evaluate characteristics of the detected mobile phone signal to determine that the detected at least one mobile phone signal originated from the predetermined location.

In this example, the detection system may include a network interface device 720 that is operative to communicate with at least one remote server 732 through a wired and/or wireless network 730. The at least one processor is operatively programmed to send information to at least one remote server, which information includes data representative of the detection of the at least one mobile phone signal originating from the predetermined location.

As described below in more detail, some embodiments of the detection system may include a radiation transmitter device 714 (e.g., an infrared light illuminator) operative to transmit radiation such as non-visible radiation (e.g., infrared light) toward the predetermined location. Also, as described below in more detail, in such embodiments the system may also include at least one radiation receiver device 716 (e.g., an image capture device such as a still or video camera) that is operative to receive portions of the radiation after the portions of the radiation have reflected off of matter inside and outside a vehicle.

In addition, as described below in more detail, some embodiments of the detection system 700 may include at least one data store 718, a user interface 722, a velocity measure device 724, and/or an interruption signal transmitter device 726 (also referred to herein as a blocking device). The data store 718 may correspond to a memory device operative to store software, configurable information, images, logs, and another data generated by or used by the at least one processor and other devices in the detection system. The user interface 722 may include one or more input devices and output devices through which a user may configure and operate the detection system. As discussed below in more detail, the velocity measure device 724 may include a device that is capable of determining the velocity of a vehicle remotely (through images from a camera, laser/radar detector, etc.) or may include a device that is capable of determining the velocity of the vehicle while mounted in the moving vehicle (e.g., a GPS).

The interruption signal transmitter device 726 is operative to generate an RF signal capable of stopping or at least degrading a voice communication call or other communication being carried out through a detected mobile phone signal. Such an RF signal may have a frequency and/or may include information which degrades the ability of the RF receiver in the mobile phone to acquire a mobile phone signal from a cell tower for use with carrying out communications with the mobile phone. In another embodiment, the RF signal may have sufficient power to modify the electrical characteristics of the antenna of the mobile phone in a manner that prevents or degrades the ability of the antenna to pick up an RF signal from a cell tower.

In some example embodiments, the user interface 722 of the system may include one or more output devices. Such output devices may be operative to emit audible sounds, visible lights, and/or human perceptible signals corresponding to an alarm, warning, or other message, which indicates that mobile phone use has been detected (and should be discontinued).

Although the detection system 700 has been described as including these various devices, it is to be understood that not all embodiments may include each of these devices. Rather, as explained below in more detail, different embodiments may include different sets of these devices, depending on the particular functions needed for the detection system.

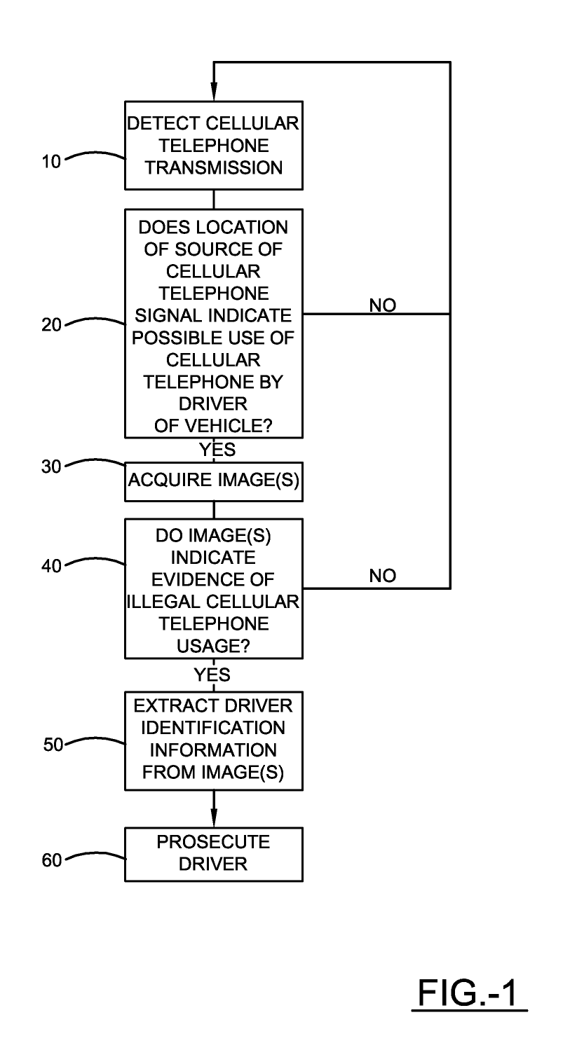

For example, some states and other jurisdictions have passed legislation to forbid drivers from using hand-held mobile phones while driving. Other jurisdictions may forbid all mobile phone use while driving, including the use of hands-free phones. An example embodiment of the detection system includes a method of acquiring information leading to the detection and documentation of illegal mobile phone usage by a driver of a vehicle. This method is illustrated in the flowchart in FIG. 1.

A first step 10 in the method may include detecting a transmission from a mobile phone. A second step 20 in the method may include carrying out an evaluation of the signal to determine whether the signal indicates possible use of a mobile phone by a driver (or other person) in a vehicle. This evaluation may comprise identifying a geographic location of the source of the mobile phone signal transmission, and determining whether that location corresponds or potentially corresponds to a predetermined location within the physical bounds of a roadway.

If the source of a mobile phone signal transmission does not correspond, or likely does not correspond, to a predetermined location within the physical space of a roadway, then no further action need be taken, and in that event, listening for and detection of appropriate transmission signals can continue. If there is detection of a mobile phone signal transmission which originates or is likely to have originated within the physical boundaries of a roadway, this can initiate or permit further action which can comprise the acquisition of image data and/or other sensors.

The detection of a mobile phone transmission can comprise operating a mobile phone signal receiver device which may be tuned to detect signals at appropriate frequencies of the electromagnetic spectrum which is characteristic of mobile telephony usage. In current mobile telephony technology, there are several commonly used signal protocols and signal frequencies. Signal frequencies used for cellular and data transmissions include 900 MHz, 1.8 GHz and 2.1 GHz. Protocols include frequency division multiple access (FDMA), code division multiple access (CDMA); wideband CDMA; Universal Mobile Telephone System (UMTS); and time division multiple access TDMA such as GSM (Global System for Mobile Communications). Other protocols include satellite telephone, Wi-Fi, analog cellular services (AMPS, or Advanced Mobile Phone Service) and GPRS for cellular data services, which could carry voice via Voice Over Internet Protocol; and WiMAX. Also, other protocols and wireless frequencies exist and are continually being developed. As used herein a mobile phone signal is defined as any type of wireless RF signal through which a mobile phone (or other wireless device such as a tablet, laptop, or a communication device integrated into a vehicle) may wirelessly and remotely communicate voice, SMS/MMS messages, and/or data (TCP/IP network communications, or other digital information).

Any particular protocol may have associated with it, its own transmission frequency and its own standard source strength. The source strength of the mobile phone signal transmission may be relevant for establishing a relationship between the signal strength received at the receiver and the distance between the transmitter and the receiver. It is possible that detected signal strength may be used as an indicator of how close the transmitting mobile phone is to the receiver, through the use of a known relationship between signal strength and distance. Because of the differences among the various protocols, such a relationship may be unique to a particular frequency band which is being monitored. There may be one relationship for one frequency and a different relationship for a different frequency.

In appropriate situations, the method may include a step 30 of acquiring images of the vehicle in the form of still images or video or both using an image capture device such as a camera. Such images may be acquired from one camera or vantage point or from more than one camera or vantage point, as discussed elsewhere herein. At least some of the images may depict the driver and the portion of the vehicle in the region of the driver. At least some of the images may comprise sufficient detail to enable visual evaluation and decision-making about the existence of illegal mobile phone usage, as described elsewhere herein. The images, or other information acquired at the same time as the images, may be suitable to identify exactly where in the roadway the vehicle was when the images were taken, and to establish the existence of illegal mobile phone usage.

Acquiring images may further comprise acquiring other information which may be associated with those images, such as the time when the images are acquired and the location where the data is taken. Also, at least some of the acquired images may be suitable for identifying the vehicle or its driver, typically by acquiring an image of the vehicle's license plate. Any or all of this image acquisition may continue for a predetermined duration of time after the start of image acquisition, and then may cease.

In addition, other information associated with the vehicle may also be acquired by one or more sensor devices. For example, a sensor device may include a vehicle velocity measure device such as a radar or laser gun capable of detecting the velocity of the vehicle. Such a vehicle velocity measure device may be located in a different location than the cameras. In other embodiments, the road adjacent the mobile phone signal receiver devices may include other types of sensor devices, such as a vehicle presence detection device. A vehicle presence detection device may include mechanical sensors which are activated by the weight of the vehicle. Such a vehicle presence detection device may also include optical, electromagnetic and ultrasonic proximity detection sensors. Also, it is to be understood that one or more image capture devices may correspond to the presence detection device. In example embodiments, the captured images and any other acquired information regarding the speed and/or position in time of the vehicle may be stored for later access to enable the system, law enforcement personnel, or other users to decide whether a law has been violated.

According to the details of current legislation in various jurisdictions, transmission of a mobile phone signal from within the physical boundaries of a roadway may indicate but does not necessarily indicate activity which is legally prohibited. There are several possibilities, as follows. One possibility is that a passenger in a vehicle, rather than the driver, may be using a mobile phone. Presumably this may be legal in many jurisdictions. Another possibility would be that the vehicle driver is using a hand-held mobile phone while driving. If there is any form of mobile phone usage which is illegal in a particular jurisdiction, most likely it is this activity which would be illegal. (However, in the event that traffic in the particular roadway was at a standstill or the vehicle were on the shoulder of the roadway, such usage would presumably be legal). Yet another possibility is that the driver might be engaged in a mobile phone conversation using a hands-free apparatus while driving. In some jurisdictions this action may be legal even if those same jurisdictions forbid use of a hand-held mobile phone by the driver. In other jurisdictions, use of a mobile phone by a passenger while the car is moving may be legal, while in other jurisdictions it may not be legal for the passenger to use the mobile phone while the car is moving.

An embodiment of the described method may include a method step 40 of evaluating the images and other acquired data to make a determination as to whether a law has been violated with respect to the particular mobile phone call detected. For example, image analysis may be used to determine if the car is moving during the time period that mobile phone use was detected. Further, the location of the vehicle in the images or the location detected by positional sensors in the road could be correlated with the features of the signals to verify that the particular vehicle being imaged corresponds to the vehicle from which cellular signals are emitting. In addition, a velocity captured for the vehicle may be compared to features of the mobile phone signals to verify that the vehicle being monitored is the correct vehicle from which mobile phone signals are being detected.

For example, the rise and fall of the signal strength of the mobile phone as the car moves toward and then away from an antenna of a mobile phone signal receiver device may be evaluated to determine a velocity of the mobile phone device. Such velocity information determined from the mobile phone signal may be compared to the velocity information determined from image data and/or a vehicle velocity measure device. Correlation between the velocity information determined from the mobile phone and the velocity information determined from image data and/or other vehicle velocity measure devices may be used by the system to determine that the vehicle being imaged corresponds to the source of the mobile phone signals. Also, the system may verify that the position of the vehicle at the peak signal strength for the mobile phone signal corresponds to the vehicle being at its closest position relative to the mobile phone detection sensor.

In further embodiments, the system may include image processing capabilities which are operative to determine whether the driver or passenger is holding a mobile phone. Further, such image analysis may determine if a passenger is present in the vehicle. In embodiments of the method, one or more of these described determinations, correlations, and verifications may be carried out to determine if there is evidence that illegal mobile phone usage is taking place in a particular moving vehicle.

In some embodiments, although one or more of these described determinations, correlations, and verifications may be carried out through operation of a computer processor in the system, it is also to be understood that one or more determinations may be carried out manually. For example, the system may make available one or more of the captured images, video, positional data, velocity data, signal strength data, and/or any other data captured by the system associated with an event. Law enforcement personnel or other users may view recorded images and may visually determine whether particular images show evidence of illegal mobile phone usage (such as use of a hand-held mobile phone) by a driver of a vehicle. If examination of images and/or other captured data indicates violation of a law by the driver (or passenger) of the vehicle, then the method may include the further step 50 of extracting information from images which can be used to automatically determine through operation of a computer and/or manually determine the identity of the vehicle or driver or both, such as from the license plate of the vehicle. In further embodiments, the system may include one or more cameras positioned to specifically capture license plate information from the front and/or the back of a vehicle.

In addition, the method may include a step 60 of initiating the prosecution of the offender for illegal mobile phone usage. For purposes of prosecution, the images may be suitable to serve as evidence which can be used during prosecution of the offender. In an example embodiment, the system may be operative to save in a local data store (and/or a data store associated with a remote server) one or more records corresponding to the event of the mobile phone usage. Such records may include the time, location and all or portions of the data captured for the event.

To initiate the prosecution, the system may be capable of facilitating the mailing of notices in the form of traffic tickets to the owner of the vehicles. Such notices may include a printed copy of the image(s) showing the illegal mobile phone usage, the license of the vehicle, and/or any other evidence captured by the system. Such tickets may include relevant information associated with how to pay the appropriate fine and/or the date to appear before a local court responsible for prosecuting the traffic violation.

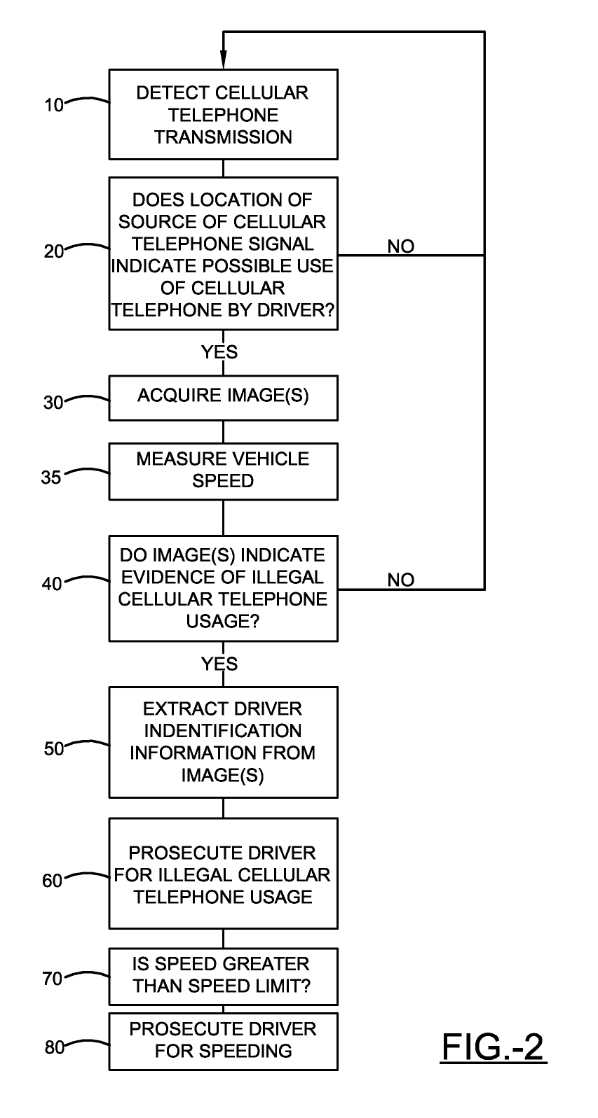

Also, it is to be understood that the example described with respect to FIG. 1 is one of many variations of the method steps that may be carried out to determine that a particular vehicle is the source of illegal mobile phone use. For example, FIG. 2 shows an alternative embodiment. Here the method comprises a step 35 of measuring the velocity of the vehicle in addition to capturing images of the vehicle. The method may include a further step 70 of determining whether a speeding violation has been committed, responsive to the velocity of the vehicle detected and the speed limit for the section of the road being monitored by the system. In addition to prosecuting the driver for illegal mobile phone usage, the method may also include at step 80 prosecuting the driver for exceeding the speed limit. Some of the same information acquired, such as license plate information, could be used for both prosecutions.

It is to be understood that in alternative embodiments, it may also be possible to perform a similar set of combined data acquisition (mobile phone usage and speeding) but to execute decision-making steps in a different order; namely, to first detect speeding violations, and then, for those vehicles for which a speeding violation is detected, examine for illegal mobile phone usage.

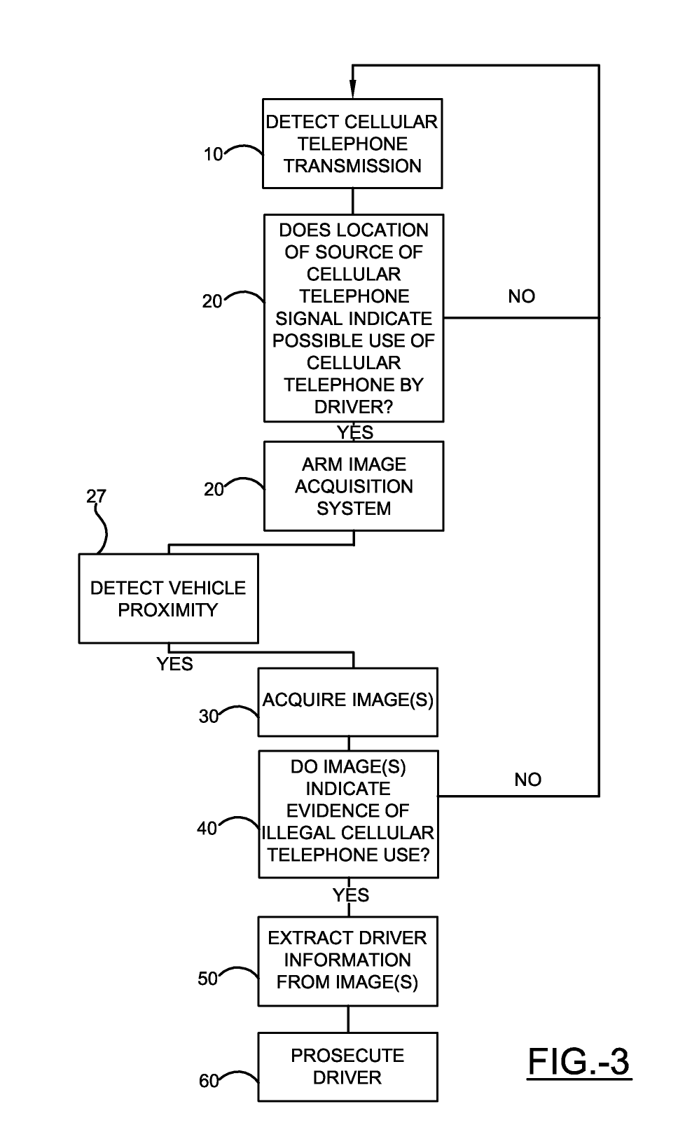

A further alternative embodiment of a method for detecting illegal mobile phone usage is shown in FIG. 3. It can be appreciated that the methods already described and illustrated with respect to FIGS. 1 and 2 may include many images acquired during an event that may not be useful for purposes of identifying illegal mobile phone usage. To enhance the efficiency of the system, the system may be operative to acquire images which can be used to more easily discern whether a driver is illegally holding a mobile phone while driving. As shown in FIG. 3, the method may include a further step 25 of arming the image capture device(s) of the system, responsive to the detection of an appropriate mobile phone signal. Before image acquisition takes place, the method may include a step 27 of detecting and evaluating data from other sensor devices, such as a vehicle presence detection device to determine when the car is properly positioned for image capture. When the vehicle presence detection device indicates that the car is located in a predetermined location, the system may then trigger the step 30 of acquiring images. In this described embodiment, the predetermined location may include a location that enables one or more cameras to acquire detailed images of the driver from the front and/or side of the vehicle. The method may further comprise acquiring more than one image at least approximately simultaneously, such as one image depicting the driver and another image depicting a license plate of the vehicle (or images depicting both license plates of the vehicle).

In an embodiment where the presence detection device corresponds to an image capture device such as a video camera, software operating in one or more computers may be operative to determine the location information for the location of the vehicle from the images acquired by the image capture device. The location information may be used to trigger when further image capture devices are operated to capture images of the drive of the vehicle. Also, the location information may be correlated by the system with the mobile phone signals to determine that the vehicle (the presence of which is detected and the image of which is being captured) is in (or was in) a location that corresponds to the location for the source of mobile phone signals.

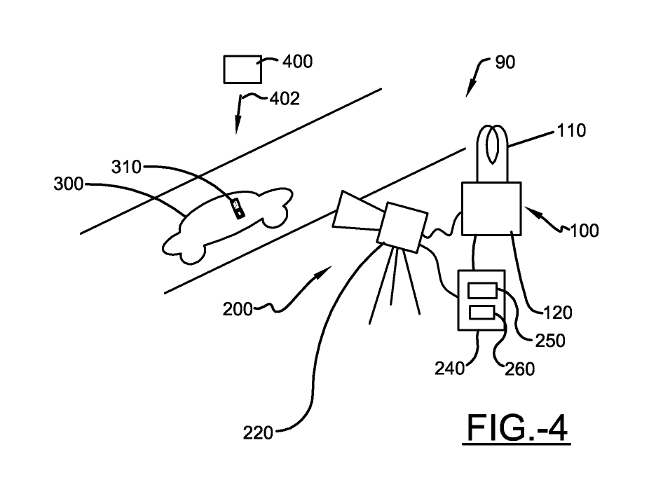

An embodiment may also comprise an apparatus such as a detection system 90 suitable to perform the described method steps. Such a detection system is illustrated in FIG. 4. The detection system may comprise at least one mobile phone signal receiver device 100 which may comprise at least one antenna 110 in operative connection with at least one receiver 120. The antenna 110 may be suitable to receive signals transmitted from a mobile phone 310 such as a cellular telephone in the vehicle 300. The receiver 120 may be tuned or may comprise a filter which is capable of detecting signals whose carrier frequency corresponds to at least one typical mobile phone signal transmission. For example, for common cellular telephone technology, the carrier frequency being monitored may be chosen to be approximately 900 MHz or 1.8 GHz and/or 2.1 GHz.

The described system may use the signal strength of a signal at the selected carrier frequency, as an indicator of distance between the transmitting mobile phone 310 and receiving antenna 110. As discussed elsewhere herein, the antenna 110 may be an antenna which is only able to receive signals which are fairly strong; i.e., signals having a strength which corresponds to a typical cellular telephone transmitter being located within a known, fairly short distance from the antenna 110. Such an antenna would ordinarily be considered a poorly designed antenna, but may be appropriate for use with the described embodiments to avoid detecting mobile phone usage outside the desired detection area. Alternatively, the antenna 110 may be a better-designed antenna with better capability for receiving transmitted signals, and the received signals may be provided to receiver 120, but receiver 120 may comprise a threshold detector such that signals below a predetermined strength are ignored. Signals received by antenna 110 may then enter the receiver 120 where they can be amplified, analyzed, recorded or otherwise processed for purposes of the embodiments described herein.

An embodiment of the detection system may further comprise an image acquisition system 200 which may comprise at least one image capture device 220. Examples of an image capture device include a still camera, video camera, or any other device operative to capture a visual image of at least portions of the vehicle. In an exemplary embodiment, the image capture device may include the capability of generating digital images. However, it is to be understood that the image capture device may also be capable of producing an analog signal corresponding to the captured image or video. In such cases, the image acquiring system 200 may further include a frame grabber board, video capture board, or other image conversion device that is operative to convert analog imaging signals into digital images. However, as discussed below, such an image conversion device may be included in other elements of the detection system.

The image acquisition system and/or one or more image capture devices may be commanded or armed to operate upon receipt of a command from receiver 120 (or a computer associated with the receiver), which command indicates that possibly illegal mobile phone transmissions are emanating from a location in or near the roadway. In exemplary embodiments, the image acquisition system 200 may comprise more than one image capture device, for example pointed in different directions and operative to image the vehicle from different vantage points to capture pictures or video of the driver region of the vehicle and/or the front and rear license plate areas of the vehicle. For example, the system may include a first video camera orientated to capture images from the side of the driver of the vehicle, while a second video camera is orientated to capture images of the front of the vehicle, while a third video camera is orientated to capture images of the back of the vehicle. With this arrangement, the three video cameras may capture images of the driver, the rear license plate, and the front license plate (if present).

In addition, the image acquisition system may include image capture devices operative to acquire images both from a vantage point somewhat to the left of the driver and a vantage point somewhat to the right of the driver, so as to be useful in detecting either a mobile phone held in the driver's left hand or a mobile phone held in the driver's right hand. Alternatively, an image capture device may be oriented to acquire only one such image. For example, the image capture device may be oriented such as to acquire an image obtained from a vantage point sufficiently close to straight in front of the driver so that the image could be used to detect the presence of a mobile phone in either hand of the driver.

In embodiments of the system, the image capture devices may be capable of acquiring images of a vehicle with sufficient resolution to determine and document the license plate or other identifying information about the vehicle or to document in sufficient detail what, if anything, the driver is holding. Also, the image acquisition system may be capable of acquiring more than one image over time pertaining to a particular possible violation event and may be capable of acquiring more than one image from more than one vantage point over time, such as any combination of front, rear and/or side image and/or images at different angles captured over several seconds or longer.

In addition to the captured images of the vehicle, the detection system may also be operative to acquire (and store in association with the images) other desired information about when and where the image was acquired, or any other information of interest. The information about where the images were taken could come from a global positioning system which is part of the detection system. Alternatively, the information could be entered or programmed into the system at the time the system is set up or installed in a particular location. In addition, the detection may also be operative to store (in association with the images) information from or about the mobile phone signal associated with the event. For example, the stored mobile phone signal information may include determined characteristics of the mobile phone signals, such as its strength. Also, the stored mobile phone signal information may include data included in the signal such as data which identifies the mobile phone device, a telephone number, carrier, data identifying the cellular telephone towers involved in communicating with the device, and/or any other data that can be determined from the mobile phone signal.

Mobile phone signals may include an encrypted portion. Some embodiments of the system may be operative to decrypt the signals and/or may be operative to communicate with servers which are operative to decrypt the signal and return decrypted data included in the mobile phone signal. In embodiments of the system that do not have the ability to determine the content of encrypted portions of the mobile phone signal, the system may still be operative to store a copy of the signal. Such a stored copy of the mobile phone signal for an event may be made available for use in prosecuting a person for illegal use of a mobile phone. At the time of the prosecution, the stored mobile phone signal may be retrieved from the data store and decrypted by the entity (e.g., mobile phone service) responsible for establishing the encrypted communication with the mobile phone.

During prosecution of an offender, the system may be operative to carry out or assist in carrying out correlation of the information about where and when the mobile phone signal was detected by the detection system, with information in the offender's mobile phone signal. In addition, the system may be capable of interfacing with mobile phone services to retrieve records corresponding to the particular telephone call carried out with the detected mobile phone signals. Such records may include further details of the call, such as the telephone numbers involved, the duration of the call, global positioning information associated with the location of the mobile phone at the time of the call, and/or any other information stored by the mobile phone service which facilitated the mobile phone call for the mobile phone detected by the system.

In embodiments in which the system is not capable of automatically interfacing with a mobile phone service to retrieve such telephone call records, the system may be operative to output information for law enforcement which may be used to request the relevant telephone call records from the appropriate mobile phone network.

In an embodiment, the system may further comprise a timer or clock whose time information is associated with the other information acquired. This time information may be incorporated into the images. The system may further associate or stamp acquired images with information about where the images were taken. The system may also be operative to digitally sign and/or digitally time stamp images and/or other acquired data regarding an event.

As shown in FIG. 4, the detection system 90 may further comprise at least one storage system 240 (i.e., a data store) capable of storing the mobile phone signals, images, and other acquired information for an event. Such a storage system may include a computer 250 and one or more storage devices 260 such as a hard drive, flash memory drive, tape system, or any other device capable of storing the acquired information for an event. Also, all or portions of the data for each event may be stored in one or more records of a data store such as a database managed by the computer and stored on the storage device or stored in a remote server in operative connection with the computer.

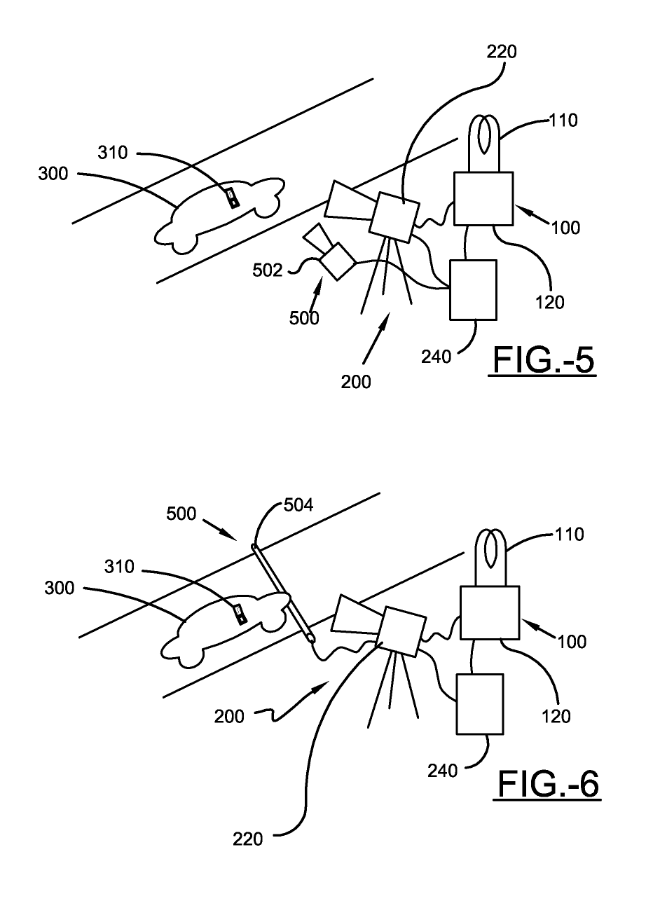

The computer associated with the described storage system may also be operative to control operation of portions of the image acquisition system 200, such as the image capture devices 220. The computer of the storage system may further be operative to control operation of the receivers 120. However, it is to be understood that the detection system may include a computer that is physically separate from the storage system 240, which computer is operative to interface and control the one or more of the components of the described detection system. As discussed previously, in addition to capturing images of the vehicle associated with mobile phone signals, the system may include one or more sensor devices operative to acquire other features of the vehicle. For example, as shown in FIG. 5, the system may include a sensor device 500 in the form of a vehicle velocity measure device 502. Another example of sensor devices which the system may include is a vehicle presence detection device such as motion detection devices, proximity detection devices, vehicle position sensing devices, and/or one or more image capture devices. Also, it is to be understood that the system may include any other type of sensor device capable of capturing data regarding the location, speed, identity, or any other information which may be useful for correlating a mobile phone signal with a particular vehicle and/or which may be useful with prosecuting an offender. As discussed previously, information acquired from such sensor devices 500 may be stored for the event by the storage system 240.

As discussed previously, an embodiment may further be operative to enable or arm the triggering of the image acquisition system. This further variation of the detection system is illustrated in FIG. 6. In this example, receipt of a mobile phone signal transmission by the receiver 120 would enable or arm the image acquisition system 200. FIG. 6 shows the addition of a sensor device 500 that is operative to trigger acquisition of images by the image acquisition system after the acquisition of images has been enabled or armed. Here, the sensor device 500 may be in the form of a vehicle presence detection device 504. Such a vehicle presence detection device may include a sensor strung across the roadway which registers when the force of a vehicle's tire is exerted thereon, or could be a sensor which detects the presence of a vehicle by the breaking of a beam of light, or it could be a sensor which detects the metal of a vehicle, or it could be a sensor which detects changes in capacitance caused by the vehicle, or it could be any other appropriate type of sensor operative to detect the presence or position of the vehicle. Also, as discussed previously, the sensor could correspond to an image capture device such as a video camera. Output from this sensor could serve as a trigger for image acquisition by the image acquisition system of images of the drive, license plate, or other portions of the vehicle. Image acquisition could occur or begin either immediately upon receipt of a trigger from such a sensor device 504, or could occur or begin after a known time delay after receipt of a trigger from such a sensor device 504.

In a further embodiment, the system may continually acquire video images from each image capture device which are stored in a respective buffer in a frame grabber and/or in the storage system 240. The buffer may be repeatedly overwritten with newly captured images. However, responsive to the detection of the vehicle by the sensor device 500, and/or responsive to the detection of a mobile phone signal by the signal receiver device 100, the system may be operative to begin storing portions of the buffer in a storage location outside the buffer. In an embodiment, the system may be configurable to enable selection of which images before and/or after a triggering event that should be copied and saved from the buffer. For example, upon detection of the presence of the vehicle and/or the presence of a mobile phone signal, the system may be operative to save from the buffer a pre-selected number of video frames both before and after the triggered event to a portion of the storage system 240. Also, rather than or in addition to selecting the number of frames, the system may be configurable to set the time duration before and/or after a triggered event to save frames from the buffer. The saved images may be stored in the storage system in association with any other data captured for the event.

In a further embodiment, image recording could be done on a continuous basis, and all of the images could be stored or retained. The receipt of a signal from a mobile phone or any other triggering device could cause the detection system to flag the relevant images by storing the time of the detection in the storage device. The system may alert or at least report to law enforcement that triggering events have occurred which may correspond to illegal mobile phone usage. The appropriate portions of the stored video corresponding to the times recorded by the system for an event may later be reviewed by law enforcement personnel to determine if an illegal mobile phone usage can be prosecuted. Also, it is to be understood that in some embodiments, one or more of the described image capture devices may be used by the system to carry out one or more of the previously described functions of the sensor devices 500.

In some embodiments, it is further possible that the detection system may generate reports which are relevant to use of the equipment in an unattended manner. In some embodiments, the detection system may report back to a remote server at a monitoring station (which may be a police facility or other location) any occurrence of possible illegal mobile phone usage and the associated images captured by the system. In some embodiments, the detection system may report back when its capacity for acquiring images is full or nearly full. In some embodiments, the detection system may store its acquired images and other information internally and/or may communicate such information to a remote server, either wirelessly or through wires, either at the time of acquisition of such information or upon the command to transmit such information. In embodiments, the detection system may transmit, either continuously or upon query, information about the status of the detection system. In embodiments, the detection system may comprise a display or lights suitable to display information about the status of the detection system. The detection system may comprise keypads, pointer devices or similar input features. The detection system may comprise an image display suitable to display acquired images. The detection system may comprise interfaces for connecting other systems such as for downloading acquired images and information from the detection system, or for loading instructions into the detection system.

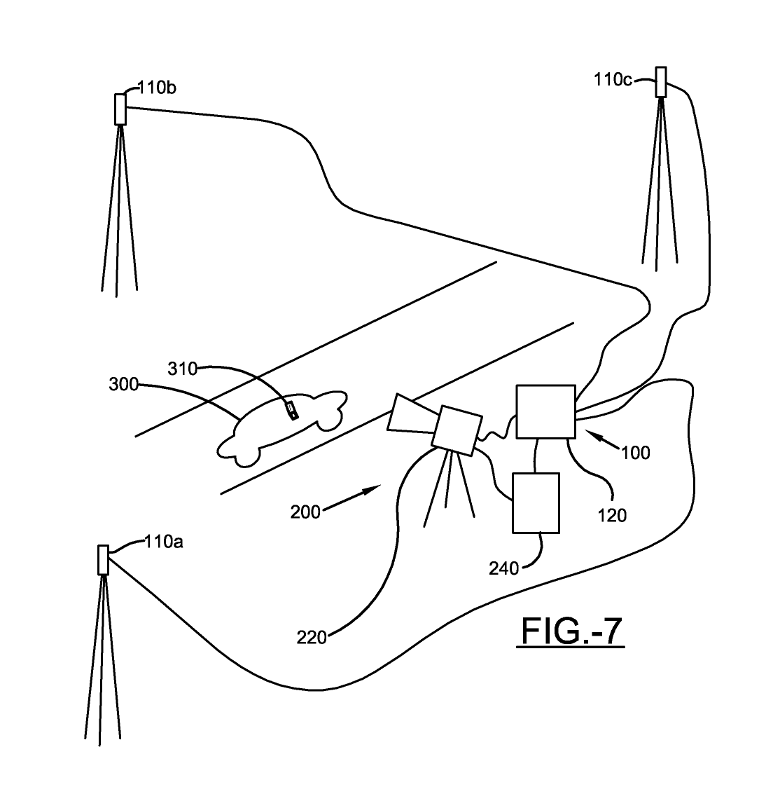

FIG. 7 illustrates a further embodiment of the system. In general, location of a transmitter can be determined by triangulation if a signal is transmitted from one location to three or more receivers at known locations (or, for signal transmission in the opposite direction, if a signal is transmitted to one location from three or more transmitters at known locations). Frequently a cellular mobile phone may be in contact with more than one cellular receiver such as a cellular telephone tower. The arrival times of signals at each of the receivers could be used to determine the position of the transmitting mobile phone, and then to determine whether the transmitting mobile phone is or is likely to be within the physical bounds of a roadway. The relative signal strengths may also enter into such a determination. FIG. 7 illustrates that three antennas 110a, 110b and 110c may be connected to one or more receivers 120. Signals from the three antennas may be used by the detection system to determine that the location from which mobile phone signal transmission is emanating corresponds to the portion of the roadway being monitored by the system. Other aspects of this embodiment can be carried out as described elsewhere herein. In a further embodiment, two antennas may provide some information about possible locations of a mobile phone signal transmission, especially if there are only a limited number of roads or likely locations. Also, changes over to time, in the signal strength or other characteristics of the received signal, can be interpreted to indicate whether the source of the signals is moving and is likely located in the roadway being monitored.

As shown in FIG. 4, in a further embodiment, the system may include a transmitter device 400 capable of communicating the presence of the jurisdiction in which mobile phone usage while driving is prohibited. The transmitter device may be positioned to continuously broadcast a warning signal 402 near the described system or elsewhere in the jurisdiction, such as adjacent a major road entering the jurisdiction. Such a warning signal may include a warning message. In an embodiment, the warning signal may be capable of interrupting an ongoing mobile phone call and cause the mobile phone device to output the warning message. An example warning message may include the verbal output of “Mobile phone usage while driving in this city is prohibited” or other suitable warning.

In an embodiment, the system may be operative to detect or determine the mobile phone number associated with the detected mobile phone signal. Using this determined number, the system may be operative to contact the mobile phone and communicate the warning either verbally or through an SMS message or other communication feature of the device. Also, the system may be operative to transmit other types of information to the mobile phone system based on the determined number of the mobile phone (e.g. advertisements, traffic information, or any other information).

In an alternative embodiment, the mobile phone may be adapted to include the capability of monitoring for warning signals. For example, manufacturers of mobile phones may include in the phone a sensor operative to detect a standardized warning signal and responsive thereto to emit an audible warning sound or verbal message.

In an alternative embodiment, rather than providing a warning, the system may contact the determined mobile phone number and communicate information regarding the violation of the law. For example, the system may communicate the message “Use of this mobile phone device was detected while moving in a vehicle. The license plate of the vehicle has been photographed and the owner of the vehicle may be cited upon further review by law enforcement.” Also in further alternative embodiments, the message communicated to the mobile phone may include details regarding the fine and/or need for a court appearance. Further, the message may include a telephone number, address or web site which can be contacted for purposes of verifying that the car has been ticketed and/or for use with paying the fine associated with the violation.

The previously described image capture devices may include still or video cameras operative to capture images of visible light. However, it is to be understood that the image capture devices may also include cameras or other devices operative to capture non-visible light such as infrared radiation.

In an alternative embodiment, infrared cameras may capture images of the vehicle which show the location of warm objects inside the vehicle, such as people. If only one warm object is detected in the vehicle, the system may be operative to determine and/or indicate that the vehicle includes only one occupant that is both driving the vehicle and using a mobile phone. Such a determination can be made using an infrared camera in cases such as at night when it is too dark to capture images of the occupants of the vehicle with a visible light camera. Also, in cases where the driver is using a hands-free mobile phone, an infrared camera determination of only a single occupant in the vehicle can be used by the system to indicate likely illegal use of a mobile phone by the driver of the car.

In addition, as discussed below in more detail, infrared image capture devices may be used to capture the interior detail of a vehicle, which details may not be visible using visible light image capture devices. For example, in order to acquire interior images of a vehicle, the image acquisition system may be capable of overcoming windshield glare which tends to obscure or hide the driver of the vehicle. When light strikes a transparent surface, part of the light is transmitted through the surface, part of the light is reflected, and part is absorbed by the material. The amount of light reflected at the surface is highly dependent on the angle of incidence. Reflection of light may be specular (that is, minor-like) or diffuse (that is, not retaining the image, only the energy), depending on the nature of the interface. Glare can be defined as the contrast-lowering effect of stray light in a visual scene. Such stray light may come from direct or reflected sunlight or artificial light such as car headlamps and street lamps.

The windshield of a vehicle must transmit 70 percent of light in the visible spectrum according to the Federal Motor Vehicle Safety Standards Part 571.205. A dirty windshield can transmit much less light and/or reflects more light than a clean one, thereby creating more glare in an image of the outside of the windshield captured by a camera. Light reflecting off of the windshield can produce a specular reflection or a diffuse reflection, depending on the light source. On a sunny day, a specular reflection from the sun can happen if the sun is directly overhead. This results in a direct reflection of the sun on the windshield creating an intense glare. On a cloudy day, the sun's rays are dispersed through the clouds giving a diffuse reflection. This results in the windshield appearing white to the observer.

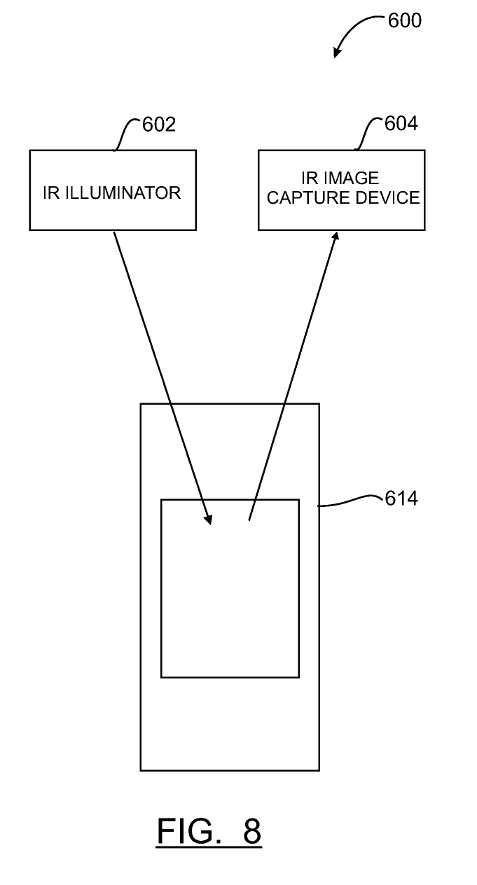

To remove and/or reduce the glare and/or remove shadows from the interior of the vehicle in images, one or more of the previously described embodiments of the image acquisition system 200 may use infrared light to illuminate a vehicle. An example of an image acquisition system 600 that uses infrared light to illuminate a vehicle 614 is shown in FIG. 8. Here the image acquisition system 600 may include an infrared illuminator 602 that emits infrared light in a wavelength that is invisible to the human eye, but is detectable by a CCD or other type of sensor of an image capture device 604. For example, an infrared illuminator may output infrared light at wavelengths above 760 nanometers.

Examples of devices capable of emitting infrared light include light emitting diodes (LEDs), halogen lamps and diode lasers. However, not all of these technologies may be capable of outputting infrared light with sufficient power to illuminate a vehicle at a distance. Thus, in exemplary embodiments, the particular infrared illuminator chosen should be capable of outputting a sufficient amount of infrared light to illuminate at least portions of vehicle from a position of at least 20 feet from the vehicle.

An example of a commercially available infrared illuminator that may be used in embodiments of the image acquisition system 600 includes an ALS-40 infrared illuminator of Electrophysics Corp. The ALS-40 infrared illuminator uses a 40 watt diode laser to produce coherent light at 810(±2) nanometers. This wavelength is invisible to the naked eye except for a faint red glow at the front of the illuminator. Infrared illuminators of this type are available with a beam angle of 10°-80° in increments of 5° both in the horizontal and vertical directions. An ALS-40 with a beam angle of 20° was used to capture the images show in FIGS. 11 and 13-15 described in more detail below.

Infrared illuminators used in example embodiments may have an optical system capable of spreading the initial diode laser beam out so that the power density is below the maximum permissible exposure according to the standards of the Center for Devices and Radiological Health of the United States Food and Drug administration (21 C.F.R. Sec. 1040) and the requirements of the International Electrotechnical Commission (IEC-60825-1). Under these standards the example ALS-40 infrared illuminator is classified as a Class 1 Laser Device which presents no danger of eye damage in the manner used in the examples described herein. Examples of optical systems which may be used in an example infrared illuminator 602 are shown in U.S. Pat. No. 6,442,713, which in hereby incorporated by reference herein in its entirety.

As shown in FIG. 8, the example image acquisition system 600 may include an image capture device 604 (e.g., digital still or video camera) having high resolution, low light sensitivity, and spectral response in the infrared region of the electromagnetic spectrum. Commercial examples of infrared cameras capable of being used for the described image capture device 604 may include a Sentec STC-400HOL camera and an ImagingSource DMK21AU04 camera. These cameras have different features and employ different CCD chips. The Sentec STC-400HOL is a monochrome camera utilizing a Sony ½″ interline CCD. The resolution is 570×485 TV lines. The camera shutter speed can be adjusted manually from 1/60 to 1/10,000 by setting the DIP switches on the camera board. The analog video signal is outputted through a BNC connection. The ImagingSource DMK21AU04 is a USB monochrome camera which uses a Sony ½″ progressive scan CCD. It has a 640×480 pixel resolution and is capable of taking up to 60 images per second. This camera has automatic adjustments for shutter speed, gain and offset.

In example embodiments, the image capture device 604 must also include a lens with a focal length appropriate for the intended spacing between the image capture device and the portion of a street/highway for which images of vehicles will be captured. For example, a 12 mm lens may be used to give a 10′×10′ field of view at about 45 feet away. This field of view approximately corresponds to one street lane wide. However, it is to be understood that in other spatial arrangements, shutter speeds, image capture devices with lenses in other focal lengths may be used.

In example embodiments, the image capture device may employ a filter to block part of the incoming light from hitting the CCD sensor of the camera. For working within the infrared region of the electromagnetic spectrum, the visible part of the light spectrum may be blocked. The previously described Sentec STC-400HOL camera is equipped with a longpass filter which blocks light below 805 nm installed between the camera sensor and the lens. For cameras that do not include a built-in filter, such cameras may be fitted with a filter that corresponds to the wavelength range produced by the infrared illuminator 602. For example, for use with the ImagingSource DMK21AU04 camera, a narrow band pass filter (NBP-810-10-45) from Infrared Optical Products centered at 810 nm may be used. Such a filter has a center wavelength of 809.6 nm and a full width half maximum of 10.6 nm, which approximately matches the type of output from the ALS-40 illuminator.

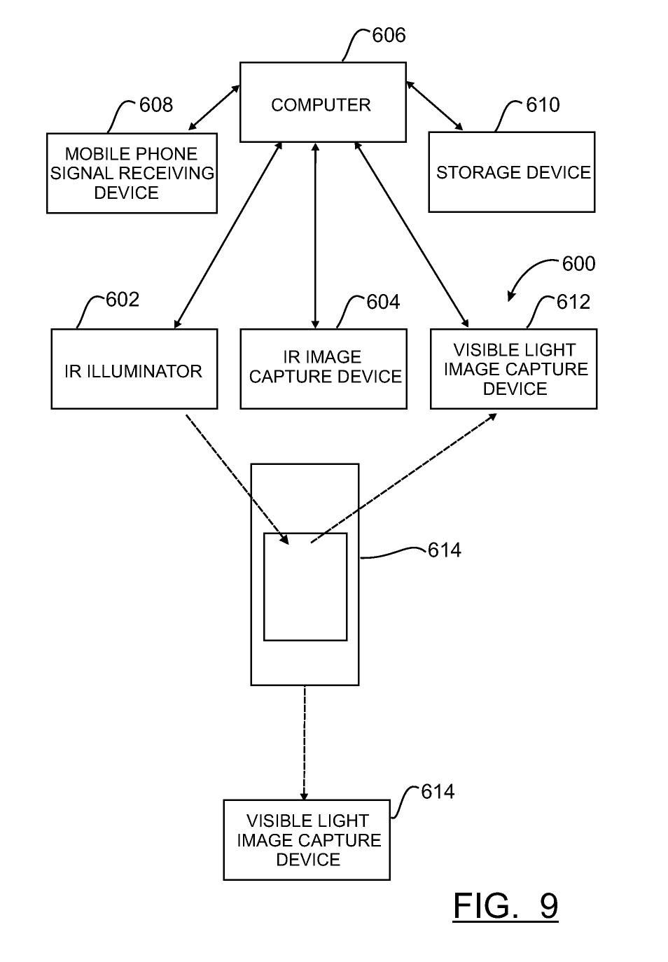

FIG. 9, shows an example of the previously described detection system which employs an image acquisition system 600 having an infrared illuminator 602. As discussed in previous embodiments, the image capture device 604 may be in operative connection with a computer 606 (which comprises at least one processor). Also as discussed previously, the at least one computer may be in operative connection with a mobile phone signal receiver device 608 and at least one local or remote storage device 610 (i.e., a data store). The at least one computer may be operative to control the image capture device to acquire images which are stored in the at least one storage device. The least one computer may also enable the images to be reviewed (e.g., accessed locally or communicated to a remote server) for purposes of determining whether a person associated with the vehicle should be prosecuted for illegal use of a mobile phone while driving the vehicle. Also, as discussed with respect to previously described embodiments, the example image acquisition system 600 may include more than one image capture device of one or more different types. For example, the image acquisition system 600 may employ at least one image capture device 604 in the form of a camera adapted to capture infrared light illuminated onto/into a vehicle 614 via an infrared illumination device 602. Also, the image acquisition system may employ at least one visible light image capture device 612 adapted to capture visible light (e.g., light from the sun or other light source) reflected from the car and/or driver. In some embodiments, the infrared camera and the visible light camera may be positioned to capture images of the car at about the same time and from similar vantage points. Such a vantage point may be chosen so as to maximize the visibility in captured images of a driver holding a mobile phone inside a typical range of sizes and shapes of vehicles. Also, visible and/or infrared light image capture devices 614 may be positioned to capture images of the license plate of the vehicle and/or other views of the vehicle and/or driver. However, it is to be understood that alternative embodiments may include one or more visible and/or infrared image capture devices positions are similar and/or different vantage points. Also, it is to be understood that one or more image capture devices and/or one or more infrared illuminator may be triggered to capture/store images and/or output infrared light respectively, responsive to one or more triggering events. Such triggering events may include the detection of a mobile phone signal with the mobile phone signal receiver device, as discussed previously. Such triggering events could also be the detection of the presence of a vehicle via the vehicle presence detection device, as discussed previously.

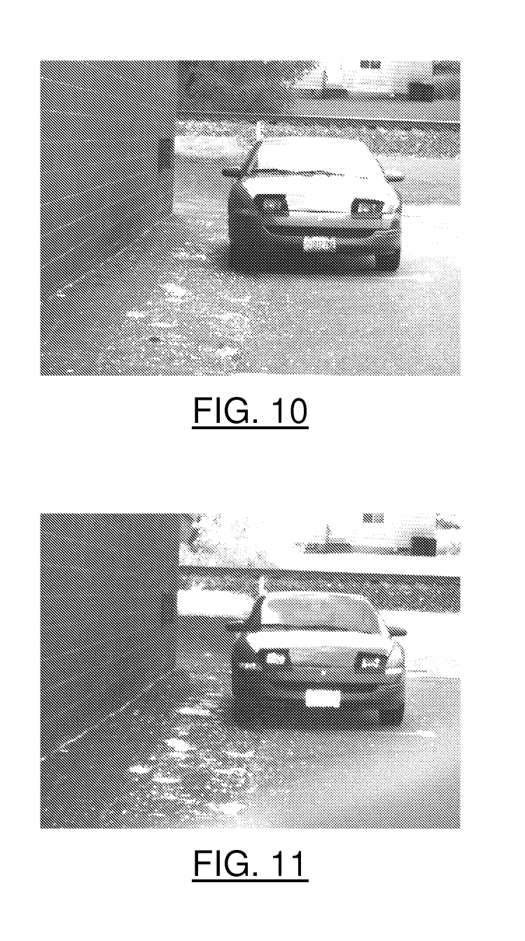

FIGS. 10-14 show examples of images captured using an embodiment of the image acquisition system 600. FIGS. 10 and 11 were taken on a cloudy day with an ImagingSource DMK21AU04 camera serving as the image capture device 604 and with the ALS-400 serving as the infrared illuminator 602. No infrared illumination was used to capture the image shown in FIG. 10. As a result, the image of the windshield appears white due to the diffuse sunlight. In FIG. 11, with the same diffuse sunlight as FIG. 10, the infrared illuminator was used to illuminate the vehicle during the capture of the image with the ImagingSource DMK21AU04 camera. In FIG. 11 the diffuse glare shown in FIG. 10 has been reduced, which enables the interior of the car to be visible.

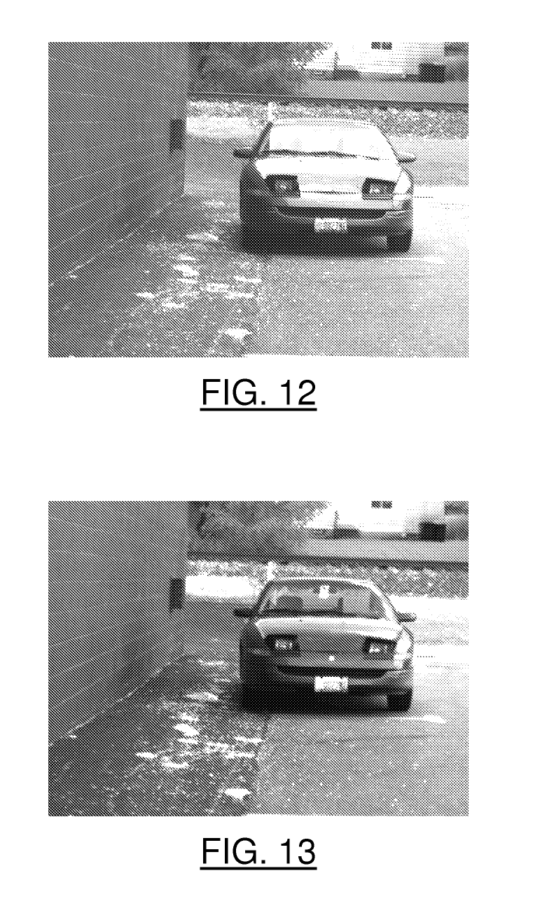

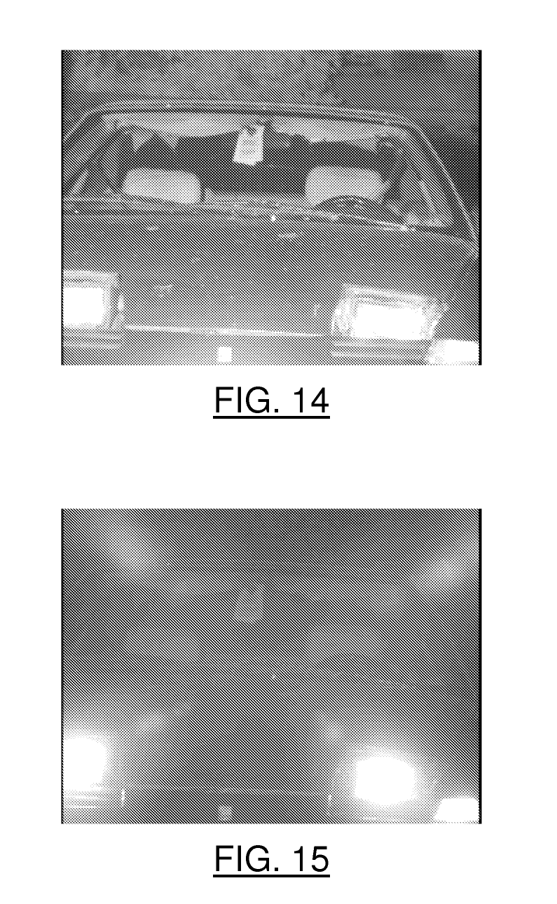

FIGS. 12 and 13 were taken during a break in the cloud cover with the ImagingSource DMK21AU04 camera. No infrared illumination was used to capture the image shown in FIG. 12. As a result, glare on the windshield significantly reduced the interior details of the vehicle captured by the camera. In FIG. 11 the infrared illuminator was used to illuminate the vehicle. In FIG. 11 the glare shown in FIG. 12 has been reduced, which enables more visible details in the interior of the car to be visible. FIGS. 14 and 15 were taken at night at a distance of 20 feet with the Sentec STC-400HOL camera with a zoom lens. Both images were taken with the infrared illuminator directed to illuminate the vehicle with infrared light. In FIG. 14 the headlights of the vehicle are off. The resulting image shows interior details of the vehicle. In FIG. 15 the headlights of the vehicle are on. Although the visibility inside the vehicle is reduced with the headlights on (compared to FIG. 14), many interior details inside the vehicle are still visible.

In addition to using visible and/or infrared image capture devices to determine information about the occupants and mobile phones in a vehicle, in alternative embodiments other types of sensors or radiation receiver devices may be used. For example, an ultrasonic detector may direct an ultrasonic signal into the vehicle. Features of the reflected ultrasonic signal may be used to determine characteristics of the inside of the vehicle.

In another example embodiment, a laser light beam may be directed onto vehicles from a laser positioned adjacent the roadway on which vehicles are moving. Reflected light from the laser light beam may be captured by a laser light sensor (and/or a camera) included in the system. Properties and/or patterns of the reflected light may be influenced by properties and/or patterns (e.g. wireless signals, sound vibrations, heat) associated with a mobile phone conversation and/or operation of a mobile phone in vehicle. Information captured from the reflected laser light beam may then be analyzed by a processor in the system to determine information useable to detect and/or corroborate illegal use of a mobile phone in a vehicle.

For example, sound waves from conversations in a vehicle (while the driver is talking on a mobile phone) may cause corresponding vibrations in the windows of the vehicle. In an example embodiment, the reflected laser light off of a window of the vehicle may include information corresponding to the vibration of the window, which is usable by the processor of the system to reproduce the conversation that occurred inside the vehicle. Details of the conversation may then be used to corroborate that the driver was talking on the mobile phone while driving.

In further embodiments, characteristics of the inside of the vehicle gathered from visible light cameras, infrared cameras, or other types of detectors such as ultrasonic detectors may be evaluated by an expert system, image analysis software, neural network, or other artificial intelligence system. As used herein, an artificial intelligence system corresponds to any device, software or system capable of determining useful information from data captured by the described detection system. Such an artificial intelligence system may be implemented as a software program in the previously described computer and/or may be implemented in a remote server operative to receive information from the described detection system. The artificial intelligence system may be operative to determine from the various types of images and other signals captured for the vehicle, whether the vehicle includes one or more occupants, and which one of the occupants is likely using a mobile phone. The artificial intelligence system may include image analysis software that is operative to determine the kind, type, and/or model of mobile phone being used. The artificial intelligence system may also include facial recognition software operative to identify features of faces in the vehicle. Such identified facial features may be used to determine identities of the occupants of the vehicle via use of a database of correlated facial features and person identities. For example, the artificial intelligence system may be operative to determine whether a particular person of interest (e.g., a wanted criminal) is present in the vehicle.

In addition, the artificial intelligence system may include software operative to determine the make and model of the vehicle, and/or other characteristics or measurements of the vehicle such as the size, the color and/or the type of vehicle (e.g., a truck, car, bus, or other type of vehicle). In addition, the artificial intelligence system may include software operative to determine information about the occupants of the vehicle, such as the number of occupants, their genders, sizes, hair color, hair styles, clothing, or any other information that can be used to distinguish one person from another person.

In an example system, the data collected and determined by the system may be stored in a local and/or a remote data store, for not only the vehicle for which mobile phone signals are detected, but also other vehicles as well. The data collected may be aggregated for use with evaluating or determining patterns and other characteristics regarding the vehicle traffic on the roadway (or roadways) being monitored.

For example, in one embodiment, the system may be operative to track the detection of the same car (via license plate number or other detected data). The system may be operative to determine if the same vehicle has traveled on the same roadway multiple times at or above a predetermined threshold over within a predetermined time period. The detection of the vehicle multiple times may be indicative of a criminal evaluating a potential target. The detection system may be operative to report the license plate number and/or other determined data for the vehicle to law enforcement or other parties for further evaluation.

In further examples, such an artificial intelligence system may include software operative to determine if other violations of the law are being committed. For example, the artificial intelligence system may be operative to determine if a seat belt is being used by one or more occupants. Also for example, the artificial intelligence system may be operative to determine if a baby carrier or child seat is present in the vehicle, and if a baby or child is presently in the baby carrier or child seat. Further, the artificial intelligence system may be operative to determine whether the baby carrier or child seat is facing in the wrong direction and/or is illegally mounted in the front of the vehicle. Further, the artificial intelligence system may be operative to determine if a baby or small child is present in the vehicle but is not sitting in a baby carrier or child seat. In addition, some jurisdictions may prohibit an adult from smoking in a vehicle while a baby or child is also in the vehicle. Determination of possible illegal activities may be reported by the system to law enforcement or other persons capable of issuing citations to persons associated with the vehicle.

In embodiments of the described system, the image capture devices may be operative to capture multiple images of a vehicle as it moves along a road. For example, the image capture devices may be capable of capturing multiple images per second. Each image may show the vehicle in an offset position and/or with a change in size, depending on the direction of travel of the vehicle with respect to the location of the camera.

These images may be evaluated by at least one computer in the system to estimate the velocity of the vehicle. The at least one computer may include image evaluation software capable of detecting and quantifying changes in the size and/or location of the vehicle captured in a set of images. Using known information, such as the time each image was captured and the relative geometric positions between the cameras and the moving vehicle, the software may be configured to determine an estimate for the velocity of the vehicle.

For example, an image capture device may be positioned to capture images of the license plate of a moving vehicle. License plates typically have a rectangular shape with a width and height that can be readily measured by software analyzing the images. License plates also include numbers and/or letters with sizes that can be readily measured from the captured images. An example embodiment of the software may be operative to compare the measured widths of identifiable features (e.g., plates, letters, numbers, and/or the vehicle itself) in the images to determine a change in size of one or more features from one image to the next image in time. Velocity of the vehicle may be determined based on the change in size of the measured feature and the amount of time that has passed between the images.

Embodiments of the system may also include an initial setup procedure to configure the software to accurately measure velocity given the particular arrangement of the system. Such a setup procedure may include the input of the relative locations and/or optical features of the one or more image capture devices. Such a setup procedure may involve operating the system with one or more test vehicles moving at known velocities for purposes of calibrating/configuring the system to calculate velocity accurately from images.

In addition, features on the vehicle captured in the images, such as the lettering on license plates, may have known sizes. Such known sizes may be stored in or accessed by the software for use with calculating velocity of the vehicle captured in the images. Alternative embodiments of the image evaluation software may use the known sizes of different letters and numbers or other features of the vehicle to automatically determine velocity from the images without having the system undergo a manual calibration setup procedure with respect to measuring velocity.

In systems with multiple image capture devices (capturing different views of the vehicle), each of the different views of the moving vehicle may be used by the system to estimate the velocity of the vehicle. The determined velocity of the vehicle may correspond to an average of the velocity measurements for the different views. Also, discrepancies between velocities associated with different views, may be used by the system to gauge the accuracy of the measurements.

As discussed previously with respect to FIG. 2, embodiments may include the system carrying out a step of determining if a speeding violation has been committed responsive to the velocity of the vehicle estimated by the system and the speed limit for the section of the road being monitored by the system. This determination can be used by the system to trigger and/or enable the prosecution of the driver for exceeding the speed limit, whether or not illegal use of a mobile phone is detected for the same vehicle.

As discussed previously, example embodiments of the described system may include components (such as image capture devices) mounted adjacent to (or in visual range with respect to) a roadway through which vehicles travel. However, it is to be understood that alternative embodiments may be mounted in other predetermined locations at which it may be desirable determine whether mobile phone communications are taking place. Such other locations may include border crossings, casinos, buildings, prisons, hospitals, airplanes, trucks, cars, construction equipment, and other types of buildings, vehicles, and geographical locations. An example of an alternative embodiment of a detection system operative to detect mobile phone signal originating from a predetermined location (e.g. a vehicle and a prison) and operative to communicate the detection (and the predetermined location of the detection) to a monitoring system, is found in U.S. application Ser. No. 12/433,219 filed Apr. 30, 2009, which is hereby incorporated herein in its entirety.

In some of these alternative embodiments, image capture devices may not be used (or needed) to determine that a mobile phone signal is originating from a predetermined location. For example, in an alternative embodiment, mounted inside a vehicle, or a room in a building (e.g., prison cell), a mobile phone signal receiver device may be configured with one or more antennas operative to provide sufficient information for a computer system in the vehicle or building to verify that a particular detected mobile phone signal is originating from inside the vehicle or room in the building (and not outside the vehicle or room). In this example, the predetermined location corresponds to the interior of the vehicle or the room of the vehicle. Upon determination that the mobile phone signal is originating from the predetermined location, the detection system is operatively configured to notify a remote server that a mobile phone signal was generated in the predetermined location.

In the case of a vehicle (or other predetermined location), the detection system may include a wireless network interface device that connects to a wireless network in order to communicate with the remote server. The remote server may then be operative to notify (via SMS messages, database logs, e-mail, web interface, or other electronic communication) a further person or entity of the detection of the mobile phone signal and usage in the particular predetermined location.

This described alternative example system may be used by employers, parents, or other parties, to receive electronic notice when a person is using a mobile phone (in violation of a company or parent rule against such use) in a particular vehicle. As described in more detail in U.S. application Ser. No. 12/433,219, the system mounted in the vehicle, may be operative to detect when the vehicle is moving and the velocity at which the vehicle is moving. Such information regarding velocity in U.S. application Ser. No. 12/433,219 was described as being used to determine when to emit an interruption RF signal (also referred to as a blocking signal) with an interruption signal transmitter device in order to disrupt the mobile phone signal in different ways depending on predetermined velocity ranges. However, in the described alternative example system, in place of (or in addition to) emitting an interruption RF signal, the system may be configured to notify the remote server of mobile phone usage in the vehicle based on the particular speed of the vehicle. For example, the detection system may include one or more configurable velocity thresholds stored in a memory of the system. When the vehicle is determined by the system to not be moving, the system may be configured to not notify the remote system of mobile phone usage in the vehicle. However, when the velocity of the vehicle is detected by the system to be greater than zero, or some other configurable velocity, the system may be configured to notify the remote server of mobile phone usage while the vehicle is moving at and/or is above such some configurable velocity threshold.

In this described embodiment, the system may include a wireless network interface device capable of communicating with the remote server through a cell phone based network. In a further alternative embodiment, the detection system may include an 802.11a,b,g,n wireless network interface device configured to communicate with a wireless access point rather than a device which communicates with cell towers. In addition, in another embodiment, the detection system may include a Bluetooth (or other short range communication signal) based network interface device that is operative to be configured to communicate with the remote server through the wireless network capabilities of the mobile phone being detected (e.g. via tethering).

In these embodiments, the detection system may store in a local data store, event data regarding the detection of one or more communication uses of the mobile phone in the vehicle. Such event data may include all or portions of each communication, the date, time, and duration of each communication, the velocity of the vehicle and/or the location of the vehicle during the detected communication (determined through a GPS device included in the system) and any other data associated with the detection of the mobile phone signal and/or the operation of the vehicle during the detection. The system may continually or periodically transmit at least portions of such collected data regarding mobile phone use events to the remote server. Also for systems that do not include a continuous wireless connection with the remote server (e.g., systems using a 802.11a,b,g,n type wireless network interface device), when the vehicle passes near a compatible wireless network in a home garage, parking lot, or other location, the system may be operative to automatically detect the network and begin communicating detected events held in the data store to the remote server. In addition, the system may be operative to wait until a request is received from the remote server through the detected wireless network prior to sending the data stored in the local data store to the remote server.

In this described embodiment of a detection system mounted in a vehicle, the system may be operative to record in the data store, all or at least a portion of the wireless communications (voice and/or data) transmitted from the detected mobile phone (which as discussed previously may include any type of communication device operative to communicate wirelessly from the vehicle). In addition, an alternative embodiment may be operative to automatically detect which wireless signals are being received by the mobile phone in the vehicle and to record all or at least a portion of these received communications as well in the data store.

The storage (and/or the reporting to the remote server) of such data regarding the detected communications may occur for all detected communications or may be triggered based on the detected velocity of the vehicle surpassing a configurable threshold stored in the system. However, alternative embodiments may also be operative to trigger the storage (and/or the reporting) of such data regarding a detected communication on other events such as the time of day, a schedule, the frequency band of the communication, the type of communication (e.g. voice or data), or any other information regarding the use of the mobile phone, the operation of the vehicle, or any other data accessible to the detection system inside the vehicle.

As discussed previously, embodiments of the detection system may correspond to a device mounted in the vehicle that is operative to directly detect mobile phone signals originating from mobile phones inside the vehicle (via an antenna which receives the mobile phone signal). However, an alternative embodiment may be operative to detect mobile phone usage by monitoring Bluetooth signals (or other short range wireless signals) between a mobile phone in the vehicle and a hands free device. Thus, as used herein the detection of a mobile phone signal (such as those between the mobile phone and a cell tower) may also include the detection of such signals indirectly through detection of other signals transmitted to and/or received from the mobile phone (e.g. Bluetooth).

Also, the detection system may be operative to determine a mobile phone number or other identifying information from the mobile phone signals detected by the system. Detected identifying information may be stored in a data store of the system. The system may be operative to compare identifying data currently being detected to corresponding identifying data previously stored in the data store of the system to further corroborate that the detected mobile phone signals originated from a mobile phone likely being used by the driver of the vehicle (rather than from a random mobile phone of another person outside the vehicle.)

In addition, in embodiments in which the detection system is mounted in a vehicle, room, or other location, the system may include, or be in operative connection with radiation receivers (also mounted in the vehicle, room, or other location) which detect radiation other than mobile phone signals. For example the system may include a camera that is operative to capture images of the driver and/or a microphone that is operative to capture an audio recording of the driver talking. Such images and audio recordings could be evaluated (by the detection system itself, another remote system, and/or a human) to determine if the person depicted in the images or talking in the audio recordings, was using a mobile phone. In further embodiments, the radiation receiver mounted in the vehicle or other location in operative connection with the described system may detect other types of radiation, including other types of electrometric radiation and/or particles emitted in the vehicle or other location.

In example embodiments that include an interruption transmitter device, the system may include a direction antenna capable of emitting an interruption RF signal at a higher power in one direction relative to an opposite direction. For example, as shown in U.S. application Ser. No. 12/433,219, the antenna that emits the interruption RF signal may be mounted under the seat of the driver of a vehicle and may be operative to emit an interruption RF signal at a higher power generally upwardly, relative to the power of the interruption RF signal emitted in other directions from the antenna. For example, the antenna may be adapted to transmit the interrupting RF signals upwardly in directions in which substantially all of the power of the emitted RF signals is directed substantially within 80 degrees of a vertical axis. Also it should be appreciated that the detection system and/or antenna may be mounted in other locations (other than the under the driver's seat of a vehicle) targeted at the likely source of the mobile phone signal.

In example embodiments, such an antenna may also be used to detect mobile phone signals. However, in other embodiments, different antennas may be used to receive and transmit RF signals. As an example, the antenna may have a size operative to fit under the seat of a vehicle (e.g. a size not greater than 6 inches×6 inches×15 inches. The antenna may be operative to receive and/or transmit RF signals in a frequency range of 700 MHz-2200 MHz and/or other cellular phone bands or signals that can communicated by mobile devices. The half-power beam width of the antenna may be less than 10 degree (both directions) for example. The gain of the antenna may be greater than 5 dB for example. The impedance of the antenna may be 50 Ohm for example. The SWR of the antenna may be less than 1.6 across the band for example. The forward to back lobe ratio may be greater than 20 dB for example. The antenna may also include a single SMA female connector or other type of connect for connecting the antenna to the described system. However, it should be appreciated that in other embodiments, other types of antennas may be used to receive and/or transmit RF signals.

In addition, in a further alternative embodiment of the detection system, the detection system may correspond to software and/or firmware that is installed on a mobile phone being monitored. In this embodiment, the processor (which carries out the described functions of the detection system) is the processor of the mobile phone. Also in this embodiment, the mobile phone signal receiver device, may include software that is operative to detect when the mobile phone is being used (e.g. to make calls, text message etc.) through the internal software, data, and/or hardware of the mobile phone.

In this described embodiment, the detection system may communicate with the remote server through the communicating features of the mobile phone. For example, if the mobile phone includes Internet access, the described detection system may use the Internet access of the mobile phone to communicate with the remote server through the Internet. However, if the mobile phone only includes voice communications (e.g. no Internet access), the described detection system may be operative to call a phone number associated with the remote server in order to communicate data via a modem connection.

In addition, in this described embodiment, the detection system may use the GPS capabilities of the mobile phone to determine the location and/or velocity of the vehicle. In this embodiment, the detection system is operative to determine that the detected mobile phone signals (detected via software/hardware) are being transmitted from a predetermined location corresponding to the inside of a vehicle, based on the detected velocity surpassing a predetermined threshold. For example, when the determined velocity is relatively low and is compatible with a person walking (e.g., 2-4 miles/hour), the detection system may be operative to not report the detection of transmission of the mobile phone signals to the remote server. However, when the velocity is above a threshold typically associated with a moving vehicle (e.g., above 15 miles/hour), the detection system may be operative to store and/or report data regarding the mobile phone use to the remote server.

In this described embodiment of the detection system operating in the mobile phone, the detection system may correspond to a detection application that is downloaded and installed on the phone. Such a detection application may have security features which prevent a user (without a proper password or other credential) from temporarily deactivating the application in order to make undetected mobile phone calls while driving the vehicle. Alternatively, if the user using the phone retains the ability to deactivate this described detection application, the detection application may include a log of when the detection application was running and may be operative to compare this to a log of when the mobile phone was powered on, in order to detect and report to the remote server that the detection application was deactivate for a period of time while the phone was still powered on.

In a further example, a mobile phone may be adapted to include a communication blocking application which automatically disables the ability of the mobile phone to receive and/or send phone calls and/or text messages responsive to the mobile phone detecting that it is moving at a velocity that is above a minimum predetermined threshold. Such a minimum predetermined threshold may correspond to 2-4 miles/hour or other velocity that is higher than a typical human walking velocity. Such a communication blocking application may be configured to allow 911 calls (or other emergency numbers) regardless of the velocity that the phone is moving. Also such a communication blocking application may be configured to allow communications when the velocity is above a configurable maximum predetermined threshold. Such a configurable maximum predetermined threshold of speed may be set to correspond to a velocity equal to or greater than a configured level that is higher than the speed of a typical car and/or is likely indicative of the user riding in an air plane or fast train rather than driving a car. This described communication blocking application may be operative to detect velocity using velocity detecting features of the phone such as a GPS, and/or via an analysis of the radio frequency signals from one or more cell towers.

In an example embodiment, the described communication blocking application may be an application that is integrated into the operating system of the mobile phone and/or is an application that is pre-installed on the mobile phone via the carrier or other entity that sells, manufactures, and/or provides the phone to the user. Such a communication blocking application may be configured to continually operate in the phone while the phone is powered on. Such an application may also lack a user selectable setting in order to attempt to prevent a user from disabling the communication blocking application.

In a further example, a disabler application which operates in the processor of the mobile phone, may be provided which disables the ability of the communication blocking application from blocking communications. Such a disabler application may also (or alternatively) be operative to disable the ability of the previously described detection application from operating to detect when the mobile phone is being used to communicate while moving above a predetermined threshold velocity. In an example embodiment, such a disabler application may be a downloadable application that is capable of being installed on the mobile phone.

In an example embodiment, the disabler application may be operative detect the presence of the communication blocking application (and/or detection application) and cause execution of the communication blocking application (and/or detection application) in the processor of the mobile phone to be to terminated or paused. In a further embodiment, the disabler application may be operative to disable (i.e., turn off) use of a GPS device or other circuitry in the mobile phone that is used by the mobile phone to detect velocity by the communication blocking application and/or detection application. In another embodiment, the disabler application may be operative to change and/or replace the velocity data provided by a GPS device or other circuitry in the mobile phone. For example, the disabler application may intercept and replace data from a GPS device indicative of a velocity (e.g., 35 miles/hour) which is above the minimum predetermined threshold to correspond to a velocity (e.g., 0-1 miles/hour) which is below the minimum predetermined threshold in order to prevent the communication blocking application from blocking phone calls and text messages.

As discussed previously, some embodiments described herein may include the use of an infrared illuminator that is positioned to transmit infrared light through a window of a vehicle so as to reflect off of a driver of the vehicle and be captured by an image capture device. Such systems may be located adjacent roads and highways in jurisdictions that prohibit drivers from holding a mobile phone to carry out mobile phone communications while driving. In another embodiment, an infrared illuminator detection device may be produced that includes one or more photo sensors adapted to detect the presence of the specific wavelength (e.g., 800 nm to 820 nm) of light transmitted from such infrared illuminators. Such an infrared illuminator detection device may include an output device such as an audible and/or visible output device that emits a sound and/or light when infrared light is detected from an infrared illuminator. In this described embodiment, the infrared detection device may be a portable device capable of being mounted adjacent to or on a dashboard or other area of a vehicle adjacent the inside windshield of the vehicle.

This described infrared illuminator detection device may also be incorporated into a radar/laser detector for use with detecting radar/laser speed detectors. This described infrared illuminator detection device may also be incorporated into and/or include an interruption transmission device capable of emitting an infrared light inside the vehicle which produces reflected infrared light that obscures the details of the inside of the vehicle that may be captured by an infrared image capture device associated with the detected infrared illuminator. The emitting of infrared light by the interruption transmission device may be triggered by the detection of an infrared illuminator using the described infrared illuminator detection device.

In previous example of systems that are operative to detect vehicles in a roadway using mobile phones (and which systems cause tickets to be issued for illegal use of a mobile phone while driving), such systems may be mounted adjacent the roadway being monitored. For example such systems may be mounted on one or more poles, buildings, towers, or other stationary structures. However, in a further embodiment such systems may be mounted on a moving vehicle such as a bus, truck, police vehicle, or other type of vehicle. As the vehicle (that includes the detection system) drives along roadways, the system may continuously monitor adjacent vehicles for use of mobile phones.

In this described embodiment, one or more cameras may be mounted to the vehicle (e.g., a bus, truck, police vehicle) to capture images of driver's of adjacent vehicles and images of the license plates of the adjacent vehicles. In addition, the vehicle (that includes the detection system) may include the previously described infrared illuminator in a position which is operative to illuminate adjacent vehicles. Further the vehicle (that includes the detection system) may include one or more mobile phone signal receiver devices and/or antennas which are operative to detect mobile phone signals being outputted from the adjacent vehicles. As in previous embodiments, at least one processor in the system (which is connected to the one or more cameras and one or more mobile phone signal receiver devices) may be operative to determine that the detected mobile phone signal originated from at least one position in the adjacent roadway in which an adjacent vehicle was present.

In this described embodiment, the system may also include a GPS, and may be operative to determine a location of the vehicle (that includes the detection system) when images of adjacent vehicles and/or mobile phone signals are detected. Such location information may be stored along with captured images, and mobile phone signal detection events and signals by the at least one processor in a local and/or remote data store. As in previously described embodiments, the information captured and stored in the data store may be used to issue and mail tickets to users associated with the license plates of the adjacent vehicles captured in the images by the camera(s) of the described system.

In example embodiments of a detection system mounted in a vehicle (to detect usage of a mobile phone in the same vehicle), the at least one processor in the detection system may be operative to cause an output device to output signals corresponding to subliminal messages which encourage a driver of the vehicle to stop using a mobile phone. Such a subliminal message may correspond to a sensory stimuli below a driver's threshold for conscious perception of the message, but which is still capable of influencing the behavior of the user (e.g. to stop using the mobile phone). In example embodiments, such subliminal messages may be in the form of a fast or low volume audible sound which verbally conveys a message to “hang up”, “put phone down” or other command that encourages the driver of the vehicle to stop using the mobile phone. Although in some embodiments, the output device (e.g., a speaker) of the user interface may be operative to output the subliminal message, it should also be appreciated that further embodiments, may be operative to cause the mobile phone itself (e.g., the speaker of the phone) to output the subliminal message (e.g. via an interruption RF signal, Bluetooth communication and/or a network communication).

In example embodiments, the described systems may be powered via any available power source. However, it should be appreciated that in some applications of the described systems (such as systems mounted in a vehicle, prison, room, etc.) a physical power line, cable, or outlet may not be available. In such embodiments, the systems may include a power receiver device that is operative to receive power wirelessly for operating system components. For example, the power receiver device may correspond to an RF power receiver device that is operative to acquire electrical power from RF signals transmitted by an RF power transmitter device (mounted in another location in the vehicle or building). In further embodiments, the power receiver may be operative to harvest power from other RF sources (e.g., RF communication signals) in addition to, or instead of using RF transmitted from described dedicated RF power transmitter device.

Also, in further examples, the power receiver device may correspond to a vibration power receiver which is operative to convert mechanical vibrations (e.g., movement vibrations in a moving vehicle) to electrical energy. In addition, in another embodiment, the power receiver device may correspond to any other type of device that is capable of harvesting power from energy sources in the vicinity of the detection system (e.g., solar cells and wind turbines).

In these described embodiments, the power receiver device may be operative to charge a rechargeable battery with the acquired electrical energy. The other components in the detection system (e.g., the processor, and other components) may be powered via the battery. However, it is to be understood that example embodiments of the described power receiver device may directly provide power to the detection system without using a battery. Examples of RF power transmitter and receiver devices that may be used in example system include the Powercast and Powerharvester modules sold by Powercast Corporation in Pittsburgh, Pa.

As discussed previously, example embodiments of the detection system may be operative to detect the presence, usage, and/or location of a mobile phone responsive to mobile phone communications between the mobile phone and a cell tower. In addition, embodiments of the described system may be operative to detect the presence, usage, and/or location of a mobile phone responsive to shorter range communications transmitted from the mobile phone, such as Bluetooth communications, near field communications (NFC), wireless Ethernet signals, and/or any other type of mobile phone signal transmitted from the mobile phone. In these described examples, mobile phone signals may be transmitted to a cell tower, another portable device, a receiver in the vehicle, a server, or other type of communication device for purposes of carrying out phone calls, sending network data, downloading web pages, streaming video, sending SMS messages, or any other type of communications with another person or system.

In addition, in a further embodiment, the detection system may be operative to detect mobile phone communications specifically designed to be detected by the described detection system. In this embodiment, the mobile phone may include an indicator feature (implemented via software and/or an electrical circuit in the mobile phone) which is operative to cause the mobile phone to generate an indicator signal (such as an Ethernet network signal, Bluetooth signal, or other RF communication signal). The described detection system may include a transmitter which is capable of detecting the indicator signal to determine the presence, usage, and/or location of the mobile phone.

In this described embodiment, the indicator feature in the mobile phone may be operative to cause the mobile phone to produce the indicator signal while the mobile phone is being used by a user in a manner that could distract the driver of the vehicle. Thus, the indicator feature in the mobile phone may generate the indicator signal when the phone is being used to make a phone call, SMS message, surf the web, play a game, or any other activity which requires user inputs to input devices of the mobile phone. The described indicator feature may be operative to detect usage of such input devices and in response thereto cause the mobile phone to transmit the indicator signal. However, it should be appreciated that at other times when the mobile phone is being safely used (to serve as a hands free navigation system), the indicator feature may be configured so as to not transmit the indicator signal.

Also, it should be appreciated that the indicator feature of the mobile phone may produce different types of indicator signals and/or include different data in the indicator signal, depending on the status of the phone. For example, the system may indicate the presence of the phone when not in active use (by a user) by emitting an indicator signal periodically or randomly (or by another pattern) that includes data indicative of the mobile phone being present but not being actively used. Further, when the device is being actively used (in a manner that could distract the driver) the indicator feature may cause the mobile phone to produce an indicator signal that includes data indicative of the active usage of the mobile phone. Such data of the active usage of the mobile phone may include the type of usage (e.g., cell phone call, web browsing, SMS messages). Also, data indicative of either the presence or active use of the mobile phone, may include other types of data such as GPS coordinates and/or any other information which is available to the mobile phone and may be useful to the detection system.

For example, the indicator feature may be operative to include GPS coordinates (acquired using the GPS in the phone) in the indicator signal. Also, the indicator feature may include any other types of data in the indicator signal such as the phone number of the mobile phone, the phone number being communicated with, names of applications being used, and/or any other information that is available to the phone. The described detection system may acquire such information from the indicator signal for purposes of logging and reporting usage of mobile phones for the particular location (e.g., vehicle, roadway, prison cell) being monitored by the detection system.

In an example embodiment, the indicator signal may be encrypted in a manner that only permits the detection system to uncover the information in the indicator signal. For example, the indicator feature could encrypt data in the indicator signal with a public key of the detection system. The processor in the detection system may have access to a corresponding private key in order to decrypt the information in the indicator signal.

The detection system may also use detected signal strength properties of the indicator signal to verify that the detected mobile phone is in the desired location being monitored. (e.g., vehicle, roadway, prison cell) and is not in some adjacent area (sidewalk, another vehicle etc.). Also, for indicator signals that include GPS coordinates, such GPS coordinates may be used by the detection system to verify that the mobile phone is in the desired location being monitored.

In addition, it should be understood that mobile phone signals other than the described indicator signal (such as phone calls through a cell tower) may also include GPS data, header data, and/or other types of data that is detectable by the detection system. Such embodiments of the detection system may be operative to uncover such data and use it to identify the mobile phone and/or verify that the mobile phone is in the desired location being monitored. For mobile phone signals that do not include GPS data, the detection system may use a plurality of antennas to carry out triangulation which identifies the location of the mobile phone transmitting the mobile phone signals. Embodiments of the detection system may also use both location data determined via triangulation and header data (or other data) in the mobile phone signal to identify, track, and/or monitor a mobile phone.

Also, it should be appreciated that some mobile phones may not include a GPS (that senses the location of GPS satellites) but may acquire location data from information provided by cell tower triangulation. Thus as used herein, location data (or position data) may correspond to GPS coordinates or any other type of data which is capable of indicating the location of a mobile phone.

In these described embodiments (that detect mobile phone signals or the described indicator signal), the detection system may include its own GPS (either in the same housing as the system, or an externally located GPS in a connected system or subsystem). The described detection system may determine whether the location data from its own GPS (which is not the GPS in the mobile phone) and the location data in the detected mobile phone signal (e.g., which was acquired by the GPS in the mobile phone) specify locations that have a predetermined relationship (e.g., are within a predetermined distance of each other).

For example, if the detection system corresponds to a stationary or moving system that detects use of mobile phones in vehicles in a roadway, the processor in the detection system may use its determined location to calculate the coordinates for locations in the roadway being monitored (via one or more cameras). The system can then monitor location data in mobile phones to determine which mobile phone signals being detected are likely (given the errors of the location data) within the calculated locations in the roadway being monitored at times when images of one or more vehicles are being detected/captured by the cameras of the system. Correspondence between the determined location of a mobile phone signal in a monitored roadway when a vehicle is present in the roadway can be used to corroborate that a mobile phone call (or other mobile phone communication) was taking place in the vehicle by the driver. It should be appreciated that this described process for determining the location of the mobile phone signal using GPS data may also be used in combination with previously described processes for determining the location of the mobile phone signal, such as by using antenna array and triangulation.

Also for example, if the detection system corresponds to a system located in a vehicle (or a building) that detects use of the mobile phones in the same vehicle (or building), the processor in the detection system may use its determined location to calculate the coordinates for locations in the vehicle (or building) being monitored. The system can then monitor location data in mobile phone signals to determine which mobile phone signals being detected are likely (given the errors of the location data) within the same vehicle (or portion of a building) as the detection system and/or are originating from a mobile phone adjacent the detection system.

In these described examples, the processor in the system may determine whether the location data within the mobile phone corresponds to (or is within a predetermined distance of) a predetermined location (e.g., a location in the roadway, vehicle, or room) determined using the location data from the detection system. However, it should be appreciated that the processor of the described system may use other features of the location data in the mobile phone signal and from the GPS in the detection system to corroborate that a detected mobile phone signals originates from a mobile phone in a predetermined location.

For example, in cases where there may be large errors between the location data and the actual physical locations of the mobile phone and/or the detection system, the processor of the system may be operative to monitor the location data to determine velocity, traveling direction, tracks (e.g., a plurality of positions over a time period), and changes in velocity, to determine that the detected mobile phone signal originates from a particular vehicle in the roadway, or in the same vehicle in which the detection system is located.

Also, it should be appreciated that the described mobile phone signal (or an indicator signal) may include data indicative of the mobile phone number of the mobile phone. An example embodiment of the detection system may include a data store comprising one or more mobile phone numbers to monitor. When the mobile phone number detected in the mobile phone signal (or in the indicator signal) matches a mobile phone number in the data store, the described detection system may be operative to begin logging and/or reporting usage of the mobile phone.

In one or more of the previously described embodiments, one or more cameras may be used to capture images of vehicles and/or persons using mobile phones in vehicles. It should be appreciated that one or more of such cameras may be mounted to mechanisms operative to articulate the direction of the camera and/or zoom in/out the lens of the camera between relatively different telephoto and/or wide angle views. Such a mechanism may corresponds to a robot arm, motorized camera tripod, or any other mechanized system that is operative to orientate a camera in different directions.

In an example embodiment, the processor of the detection system may cause the camera to move and/or zoom its lens responsive to a determined location of a mobile phone signal in order to capture images of the mobile phone, vehicle, and/or person associated with the source of the mobile phone signal. Also, it should be appreciated that the camera may be moved to follow the location of the driver in the vehicle and/or other features of the vehicle (such as the license plate) based at least in part on imaging recognition software in the system evaluating in real-time the location of the driver and/or other features of the vehicle in the video stream from the camera.

As discussed previously, the described detection systems may be operative to cause an output of information indicative of the detection of a mobile phone being used in a predetermined location such as in a particular roadway, vehicle, building, prison cell, or other location. As discussed previously, such information may be used to trigger an alarm or notification of the detection at the location of the detection system and/or at a remote location (e.g., at a monitoring system). Also, it should be appreciated that in some embodiments, the notification at the location of the detection system may have a form that is visible to a third party.

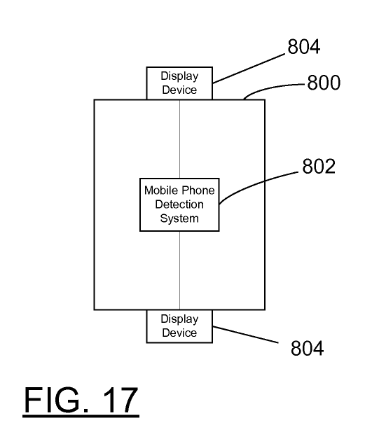

For example, as illustrated in FIG. 17, a detection system 802 may be operative to cause at least one output device such as a display device 804 to begin emitting light, or a pattern of lights which is visible to third parties. In this example, the detection system 802 and display device 804 may be mounted to or adjacent an object 800 (e.g., vehicle, equipment, building) at which a person may use a mobile phone to make a mobile phone call, send an SMS message, or other communication.

For example, the object 800 may correspond to a vehicle (e.g., a land vehicle, a water craft, an automobile, a truck, a train, a bus, a trolley, and a ship). When the detection system detects use of a mobile phone in an adjacent location in the vehicle (e.g. near the driver's seat), the detection system may activate the display device to warn drivers of other vehicles or bystanders outside the vehicle that a mobile phone is being used. Such a display device for example may be mounted to the front end and/or rear end of the vehicle. For example the display device may be mounted adjacent a license plate or adjacent another portion of the rear end of the vehicle, such that a person behind the vehicle can directly view both the license plate and the display device. Also in further embodiments, the display device may be mounted on the roof of the vehicle, adjacent a window, and/or adjacent another portion of the vehicle. When a third party sees the display device emitting light (as a result of a detection of usage of a mobile phone in the vehicle), the third party may proceed with caution and/or may notify law enforcement. Also, in further embodiments the display device may be mounted inside the vehicle such that passengers (e.g., of a bus, train, trolley, ship) inside the vehicle can view the display device.

The display device may be operative to emit light in one or more different colors. For example, the display device may include a plurality of LEDs operative to emit light directly (or through a colored plastic) with one or more colors (e.g., blue, yellow). Over time the color(s) or pattern of the light from of the display device may become known to be associated with use of a mobile phone. In further embodiments, the display device may be operative to display one or more graphical symbols and/or text which convey that a mobile phone is being used in the vehicle. For example, the display device may emit light in the pattern of a shape of a mobile phone or other symbol representative of a mobile phone. In example embodiments, display device may hold the light steady, flash the light, strobe the light, and/or change the intensity and/or colors of the emitted light.

In this described embodiment, the display device 804 may be connected via wires to the detection system 802, in order to receive power which controls the display of light from the display device. However, in alternative embodiments, the display device may be powered via an electrical connection associated with the electrical system of the vehicle. The detection system may then through wires or wirelessly send signals to the display device which turns on and off the display of light from the display device.

Also, it should be appreciated that this described third party warning system associated with the detection system may be applicable to other types of objects 800 besides vehicles. For example, companies with industrial equipment (stationary or moving) may include a detection system and a display device mounted thereon or adjacent thereto to warn others when an operator of the equipment is using a mobile phone. Also, this described detection system and display device may be mounted inside buildings and rooms to warn third parties that mobile phone usage is taking place in the building or room. In addition the display device may be remote from the detection system and be adjacent the third party. For example, the display device may be mounted to a wearable wrist band, ring, or other object that is operative to display a warning message responsive to detection of a wireless signal from a detection system.

It should be appreciated that in some embodiments described herein, a person may attempt to disable the detection system. Thus, example embodiments of the detection system may be operative to carry out one or more tests to verify that the detection system continues to be operative to detect mobile phones. For example, if the user has the ability to access the detection system, the user may unplug the electrical power to the detection system. To detect this, the detection system may be operatively programmed to periodically store a current time in a data store on the device (e.g., in a log file). The detection system may be operative to communicate the data representative of the stored times to a monitoring system (e.g., a server including at least one processor) for evaluation of the operation of the detection system. The monitoring system may include monitoring software that is operative to evaluate the time information communicated from the detection system. Discrepancies (e.g., gaps in the stored time data) uncovered by the monitoring software may cause the monitoring system to indicate that the detection system may have been disabled and/or tampered with.

In addition, a person could possibly move the detection system to another location (while leaving it enabled). As discussed previously, embodiments of the detection system may include a GPS and may include GPS location data in the information communicated periodically to a monitoring system. The monitoring system (responsive to monitoring software) may be operative to evaluate GPS data received from a detection system to verify that the detection system remains in a predetermined location (e.g., in a building, adjacent equipment, or adjacent a roadway), or verify that the detection system moves (in a vehicle) to predetermined locations in an expected pattern (e.g., to and from home and/or a place of work).

In addition, a person could possibly place shielding material (e.g., a copper mesh, aluminum foil, or other material) or a jamming device adjacent the antenna(s) of the detection system, in order to interfere with the ability of the detection system to detect mobile phone signals. An example embodiment of the detection system may be operative to periodically perform a self-test to verify that the antenna(s) of the detection system are working properly and are capable of detecting mobile phone signals. For example, the detection system may be operatively programmed to initially detect, and store in a data store, reference measurement data representative of detected background signals detected via its antenna(s).

Such reference measurement data may be captured when the detection system is initially installed, initially powered on, in response to an input through an input device of the detection system, and/or at other times. The detection system may then be operatively programmed to periodically acquire further (i.e., more current) measurement data representative of detected background signals detected via its antenna(s), for comparison to the reference measurement data. Such background signals may correspond to radio frequency signals, magnetic field strength, and/or any other electrical/magnetic properties of the antenna that are capable of being detected by the detection system.

The detection system may be operative to determine discrepancies between the current measurement data and reference measurement data that may be representative of shielding or jamming of the detection system. For example, the antenna may be operative to detect an external radio signal emitted from a transmitter installed in the general vicinity of the detection system, and/or transmitted from a third party system (e.g., AM radio broadcast). The reference measurements may be captured while such an external radio signal is active. When current measurements fail to detect the external radio signal (or detects a weaker external signal), the detection system may be operative to transmit a further communication to the monitoring system, which signal is indicative of the unit being possibly tampered with or having a detection problem (i.e., a decrease in ability to detect mobile phone signals).

In further embodiments, the detection system may include a transmitter and may output a predetermined radio frequency signal during the capture of the reference and current measurements. Detected changes in the properties of the detection of the transmitted signal between the reference and current measurements may cause the detection system to transmit the further communication to the monitoring system which is indicative of a detection problem. In alternative embodiments, the detection system may be operative to communicate the reference and current measurement data to the monitoring system and the monitoring system may determine whether the detection system may have a detection problem.

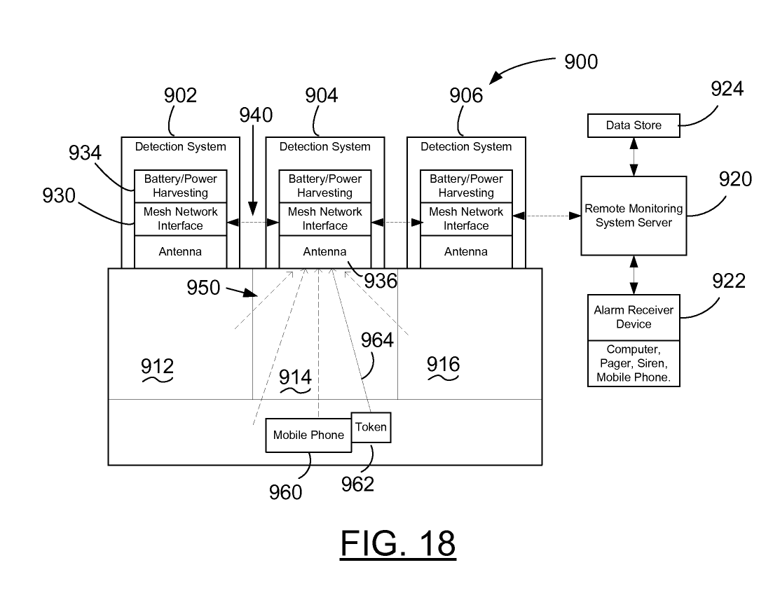

As discussed previously, embodiments of the described detection system may be employed in a prison system (or other type of building). FIG. 18, shows an example of a portion of a prison 900. Such a prison may include a plurality of prison cells 912, 914, 916 (or other rooms). To individually determine which prison cells may include use of a mobile phone therein, each prison cell may include a respective detection system 902, 904, 906 (e.g., mounted outside a window or other location). In this example, the detection system may be battery powered and may be operative to enter a low power sleep/hibernation mode/state (to preserve battery life), after a predetermined amount of time in which mobile phone activity is not detected. In an example sleep state, the detection system may be configured so as to provide no electrical power from the battery to the processor. However, in other examples of sleep states, the detection system may provide a relatively lower level of battery power to the processor compared to levels of battery power needed to process mobile phone signals.

As discussed in U.S. application Ser. No. 12/433,219 filed Apr. 30, 2009, the antenna of the detection system may include a passive antenna configured to generate a signal from a sufficiently strong mobile phone communication, which generated signal is sufficiently strong to power a circuit in the system that awakens the system from the sleep mode (which provides power or relatively more power to the processor). After being awakened from the sleep mode, the detection system may then begin operating using power from the battery to carry out one or more of the previously described functions of example embodiments of the detection system. Such functions for example that occur when the system is awakened from the sleep mode (but which do not occur during the sleep mode) may include transmitting a notification to a monitoring system 920 operative to generate an appropriate alarm communication representative of the presence of mobile phone use.

In addition, as discussed previously, embodiments of the detection systems mounted in the prison (or other location) may acquire energy to charge a rechargeable battery via power harvesting circuits 934. As discussed previously, such power harvesting circuits may include a power harvesting receiver operative to harvest RF signals from the environment or from a dedicated RF transmitter. Also, in other embodiments, the detection system may be powered via electrical lines associated with the prison building, and/or powered from a network cable.

Also, as discussed previously, the detection system may include a directional antenna 936, operative to detect mobile phone signals transmitted on one side of the antenna (or subset of angles around the antenna) at a particular distance, that would not be detectable by the antenna when transmitted on an opposite side of the antenna (or other subset of angles around the antenna) at the same distance. For example, as shown in FIG. 18, the antenna 936 may be orientated to be more sensitive to the detection of mobile phone signals in the area 950 of a prison cell 914 compared to locations in adjacent prison cells 912, 916, outside the prison cell, or on the side of the antenna opposite the prison cell.

Also, example embodiments of the detection system may include a band pass filter that is operative to detect uplink frequencies that are transmitted by mobile phones to communicate with a cell tower. The detection system may be operative responsive to the detection of such uplink signals in order to determine that mobile phone usage is taking place in the adjacent prison cell.

As discussed in U.S. application Ser. No. 12/433,219, embodiments of the detection system may include a wireless communication device in order to communicate data indicative of the detection of mobile phone usage in a prison cell to a monitoring system. In an example embodiment, hundreds of detection systems (one for each prison cell, for example) may be installed in the prison. In such embodiments, multiple access points may be employed to enable all of the detection systems to communication through a wireless network with a monitoring system (e.g., a server). However, in alternative embodiments, the detection systems may be configured to form a mesh network 940, which communicates with the remote monitoring system 920. In a mesh network, each detection system may include a mesh wireless network interface 930 which enables the detection system to communicate with the mesh network interface of other detection systems. Thus, rather than communicating directly with a dedicated wireless access point and/or a wired network, many of the detection systems may communicate messages wirelessly through other detection systems to reach a wireless access point and/or a wired network in communication with the monitoring system 920. Examples of mesh network interface technology that may be incorporated in the described detection systems include network interfaces/firmware/software compatible with the IEEE 802.11s standard. However, it should be appreciated that other mesh network components and technologies may be used such as SolarMESH, SMesh and/or other types of P2P network technologies.

In a prison system 900 or other building in which detection systems are employed, some personnel working in the prison or other building (e.g., such as a guard) may have a need to use a mobile phone 690 near the detection systems, without triggering the detection systems to communicate an alarm notification to a monitoring system 920. To enable selective mobile phone use without triggering an alarm, an example embodiment of the detection systems may be operate to determine that a detected mobile phone communication is permitted, and in response not send an alarm signal to a monitoring system.

In an example embodiment, the detection system may be operative to acquire header information or other data in the detected mobile phone signal (or an indicator signal) to determine if the detected mobile phone signal is authorized to be used. In this embodiment, the detection system may communicate the detection of the mobile phone along with the detected data to the monitoring system 920. The monitoring system 920 may then operate to determine whether the detected data corresponds to an authorized mobile phone (that is permitted to be used without triggering an alarm) by comparing the detected data to data stored in a data store 924.

In a further example embodiment, the detection systems may be operative to detect a secondary signal indicative of a person being permitted to use a mobile phone without triggering an alarm. Such a secondary signal may correspond to an RF signal 964 detectable by a receiver in the detection system (that is different than the detected mobile phone signal). Such a secondary RF signal 964 may be transmitted from a transmitter associated with a token 962 carried by a user using the detected mobile phone. Such a token may include an RFID chip/circuit or other RF transmitter that emits the secondary RF signal. In example embodiments, the token may correspond to a card, badge, dongle, ring, hard hat, or any other object that is capable of transmitting the secondary RF signal. Further, the token may be included in or be mounted to the mobile phone of an authorized user. In other examples, the secondary RF signal may correspond to an RF signal generated by the mobile phone such as a Bluetooth signal or a wireless network signal (that is configured to emit data usable to verify that the mobile phone is authorized). For example, such a secondary RF signal transmitted by a mobile phone may correspond to the previously described indicator signal.

In example embodiments, the secondary RF signal 964 may include a unique ID or other data which is detectable by the detection system 904. In an example embodiment, the detection system may be operative to verify the unique ID or other data itself as corresponding to an authorized mobile phone, and in response not send a notification to the monitoring system 920. However, alternatively, the detection system 904 may be operative to send a notification of the detected mobile phone along with the data detected from secondary RF signal 964. In this alternative embodiment, the monitoring system 920 may be operative to evaluate the data detected from the secondary RF signal and determine whether an alarm should be triggered.

In further embodiments, the detection systems throughout the prison (or other building) may be operative to send data received from secondary RF signals 964 on a continuous basis (even when mobile phone signals are not detected). The monitoring system 920 may use such data to track the location of personnel in the prison or other building.

In addition, it should be appreciated that the monitoring system may be operative to monitor detection systems that appear to have died and are in need of maintenance or replacement. For example, each detection system may be operative to periodically send a notification to the monitoring system indicating that the detection system is working properly. As discussed previously, notifications from detection systems may include a unique ID (and/or GPS location data) in order for the monitoring system to identify and distinguish one detection system from another. The monitoring system 920 may include a data store 924 including data representative of installed detection systems, and may be operative to determine when a known detection system has failed to communicate a notification signal in a predetermined time period that is indicative of it working properly. In response to this determination, the monitoring system may communicate an alarm signal to appropriate personnel, which signal identifies the location of the detection system that may need new batteries or other maintenance.

Also, it should be appreciated that some embodiments of the detection system may not include a GPS. When such units are installed in the prison, the installed location of the detection system may be stored in correlation with its unique ID (serial number, and/or a user assigned ID) in a data store 924 associated with the monitoring system. Such stored location information may be used by the monitoring system to identify a location of a detection system that has sent a signal indicating the detection of a mobile phone or the detection of a secondary signal. Such stored location information may also be used to identify the location of a detection system that has failed to send a notification indicating that it is working properly.

In addition, in a prison or other embodiment with multiple adjacent detection systems, it should be appreciated that a mobile phone communication may be detected by more than one detection system (e.g., in adjacent prison cells). In example embodiments, the detection systems may be operative to communicate data to the monitoring system that is indicative of the detected power level of the mobile phone signal detected. When multiple detection systems notify the monitoring system of a mobile phone detection, the monitoring system may be operative responsive to the location data associated with each detection system and the power levels communicated from each detection system, to determine which of the detection systems is likely closest to the detected mobile phone. The monitoring system may then issue an alarm that includes the location (e.g., a particular prison cell or other room) of the detection system that is most likely closest to the detected mobile phone.

In addition, it should be appreciated that embodiments that involve vehicles may use a similar technique to determine that a mobile phone is being used by the operator of the vehicle (e.g. a driver of the vehicle) and not a passenger or person outside the vehicle. For example, a detection system mounted in a vehicle (e.g., automobile, bus, trolley) may include a plurality of spaced apart directional antennas orientated to detect mobile phone signals in different respective locations including a first location adjacent the operator's seat and one or more second locations that are farther from the first location than the first antenna (e.g. a location adjacent a passenger seat, a bus/trolley door). The processor in the detection system may be responsive to the respective signals from each respective antenna (e.g. the relative differences in power levels of the detected mobile phone signal for each antenna) to determine when a detected mobile phone signal is more likely being transmitted from the first location adjacent the operator's seat than a second location farther from the first location than the first antenna. When the detection system determines that the detected mobile phone signal is more likely being transmitted from the first location adjacent the operator's seat, the detection system may be operative to cause a display device to emit a warning light, send an alarm communication to a remote monitoring system, and/or carry out another one of the functions described herein when use of a mobile phone is detected.

To communicate alarms and problems (e.g., detected mobile phones, low or used battery levels, detection problems), example embodiments of the monitoring system 920 may be in operative connection with one or more alarm receiver devices 922. Such alarm receiver devices may include computers, monitors, displays, pagers, sirens, flashing lights, mobile phones, tablets, printers, faxes, databases, and/or any other device including (or corresponding to) an output device that is operative to output information about the alarm to a human capable of handling the alarm. It should be appreciated that alarm notifications may be communicated via e-mail, SMS messages, phone message, electrical lines, network signals, wired/wireless communications, and/or any other form of communication to which the alarm receiver devices are capable of communicating.

In the described embodiments, the system and method steps have been described as being carried out by various components of the described systems. Such components may include one or more computers and servers having processors that are operative to carry out the steps and features described herein responsive to firmware, software, and received and stored data. For example, the computer may be operative to acquire the data captured by one or more of the described cameras, mobile phone signal receiver devices, and other sensor devices and store the data from a detected event in a data store locally and/or remotely from the computer. Further, the computer may be operative to carry out the monitoring of acquired data to determine when to trigger events such as capturing images of a moving vehicle. Further, the computer may be operative to carry out correlating data from different devices to determine which vehicle on the road is the source of mobile phone signals. In addition, the computer may be operative to carry out signal analysis and/or image analysis on the information provided by the various detectors to achieve a more accurate determination of whether illegal mobile phone usage is taking place in a particular vehicle, building, or other location. Also, the computer may be operative to carry out wired and/or wireless communication of the acquired information to one or more remote locations, such as further computers and servers operative to review, report and/or evaluate the information captured and determined by the described system.

Computer executable software instructions used in operating the described systems and connected computers may be loaded from computer readable media or articles of various types into the respective computers to cause processors to carry out the described methods herein. Such computer software may be included on and loaded from one or more articles such as compact disks, DVDs and other optical or magnetic media. Such software may also be included on articles such as hard disk drives, tapes, flash memory drives, SSDs, or other rewritable or read-only drives and storage devices. Other articles which include data representative of the instructions for operating computers in the manner described herein are suitable for use in achieving operation of the systems and methods in accordance with the described embodiments. These described articles on which software or firmware may be stored correspond to non-transitory computer readable media.

Thus the new mobile phone detection systems and methods described herein achieve one or more of the above stated aspects, eliminate difficulties encountered in the use of prior devices and systems, solve problems, and attain the desirable results described herein.

In the foregoing description, certain terms have been used for brevity, clarity and understanding; however, no unnecessary limitations are to be implied therefrom, because such terms are used for descriptive purposes and are intended to be broadly construed. Moreover, the descriptions and illustrations herein are by way of examples and the invention is not limited to the exact details shown and described.

It is noted that several examples have been provided for purposes of explanation. These examples are not to be construed as limiting the hereto-appended claims. Additionally, it may be recognized that the examples provided herein may be permutated while still falling under the scope of the claims.

In the following claims, any feature described as a means for performing a function shall be construed as encompassing any means known to those skilled in the art to be capable of performing the recited function, and shall not be limited to the features and structures shown herein or mere equivalents thereof. The description of the embodiment in the Abstract included herewith shall not be deemed to limit the invention to features described therein.

Having described the features, discoveries and principles of the invention, the manner in which it is constructed and operated, and the advantages and useful results attained; the new and useful structures, devices, elements, arrangements, parts, combinations, systems, equipment, operations, methods and relationships are set forth in the appended claims.

I claim:

1. A system comprising:
a monitoring system, wherein the monitoring system includes at least one processor;
a plurality of spaced apart detection systems operative to respectively detect mobile phone signals transmitted in a respective location adjacent each of the respective detection systems, wherein each detection system includes at least one processor, wherein the at least one processor of each detection system is responsive at least in part to a detection of a mobile phone signal transmitted from a location adjacent the detection system to communicate the detection of the mobile phone signal to the monitoring system, wherein the at least one processor of the monitoring system is operative to determine data corresponding to the respective locations associated with each detection system communicating a detection of a mobile phone signal, wherein the at least one processor of the monitoring system is operative to cause an output through at least one output device, indicative of each determined respective location of a respective detection of a mobile phone signal.

2. The system according to claim 1, further comprising a building, wherein respective locations adjacent at least a portion of the detection systems include respective rooms in the building.

3. The system according to claim 2, wherein the building is a prison building, wherein the rooms are prison cells, wherein each prison cell includes one of the detection systems mounted adjacent a window of the prison cell.

4. The system according to claim 1, wherein each detection system includes a GPS operative to determine a respective position of the detection system, wherein each detection system is operative to communicate position data determined using the GPS associated with the detection system to the monitoring system, wherein the monitoring system is operative to determine the data corresponding to the respective locations associated with each detection system communicating a detection of a mobile phone signal responsive at least in part to the position data communicated from each respective detection system.

5. The system according to claim 1, wherein each detection system includes a wireless network interface, wherein at least a portion of the detection systems are operative to form a mesh network with each other, in which communications between at least some of the detection systems to the monitoring system are communicated through other detections systems.

6. The system according to claim 1, wherein the at least one processor included in each detection system is operative to determine data representative of a reference measurement responsive at least in part to radio frequency (RF) communications received with at least one antenna associated with the detection system, wherein the at least one processor included in each detection system is operative to determine data representative of at least one further measurement responsive at least in part to RF communications received with the at least one antenna, wherein at least one processor included in each detection system is operative to cause a respective further communication to be sent to the monitoring system responsive at least in part to the data representative of the reference measurement and the data representative of the at least one further measurement, wherein the at least one processor included in the monitoring system is operative to cause a further output through the at least one output device, indicative of an detection problem with each respective detection system responsive at least in part to the respective further communication received from the respective detection system.

7. The system according to claim 1, wherein each respective detection system is operative to detect a secondary radio frequency (RF) signal transmitted from at least one of a token and the mobile phone in the respective locations associated with each respective detection system, wherein each detection system is responsive at least in part to the detection of the secondary RF signal to forgo communicating a detection of a mobile phone signal in the respective locations to the monitoring system.

8. The system according to claim 7, further comprising the token capable of transmitting the secondary RF signal, wherein the token includes at least one of a badge and a card.

9. The system according to claim 1, wherein each detection system includes a battery operative to power the at least one processor included in the detection system, wherein each detection system is operative to place the detection system into a state which provides no electrical power from the battery to the at least one processor, wherein the detection system is operative responsive at least in part to a detection of a mobile phone signal using at least one antenna, to cause the detection system to place the detection system into a further state that is operative to provide power from the battery to the at least one processor.

10. The system according to claim 1, wherein each detection system includes a directional antenna adapted to detect at least one mobile phone signal transmitted on a first side of the antenna at a first distance from the antenna, which mobile phone signals would not be detectable when transmitted on a second side of the antenna at the same distance from the antenna.

11. A method carried out with a monitoring system in operative communication with a plurality of spaced apart detection systems operative to respectively detect mobile phone signals transmitted in a respective location adjacent each of the respective detection systems, the method comprising:
a) detecting a mobile phone signal through operation of one of the detection systems;
b) through operation of at least one processor included in the detection system in (a) communicating the detection of the mobile phone signal to the monitoring system;
c) through operation of at least one processor included in the monitoring system, determining data corresponding to a location associated with the detection system communicating the detection of the mobile phone signal in (b); and
d) through operation of the at least one processor included in the monitoring system, causing an output through at least one output device, indicative of the determined location of the detection of the mobile phone signal.

12. The method according to claim 11, wherein the respective locations adjacent at least a portion of the detection systems include respective rooms in the building, wherein (a) includes detecting the mobile phone signal transmitted from inside one of the rooms in the building.

13. The method according to claim 12, wherein the building is a prison building, wherein the room in (a) is a prison cell, wherein in (a) the detection system is mounted to at least one of in and adjacent the prison cell.

14. The method according to claim 11, wherein each detection system includes a GPS operative to determine a respective position of the detection system, further comprising:
e) through operation of the at least one processor included in the detection system, communicating position data determined using the GPS associated with the detection system to the monitoring system;
wherein in (c) the at least one processor included in the monitoring system is operative to determine the data corresponding to the location associated with the detection system communicating the detection of the mobile phone signal in (a) responsive at least in part to the position data communicated from the detection system in (e).

15. The method according to claim 11, wherein each detection system includes a wireless network interface, wherein at least a portion of the detection systems are operative to form a mesh network with each other, wherein in (b) the detection system is operative to wirelessly communicate with at least one other detection system to communicate the detection of the mobile phone signal to the monitoring system.

16. The method according to claim 11, further comprising:
e) through operation of the at least one processor included in the detection system, determining data representative of a reference measurement responsive at least in part to radio frequency (RF) communications received with at least one antenna associated with the detection system;
f) through operation of the at least one processor included in the detection system, determining data representative of at least one further measurement responsive at least in part to RF communications received with the at least one antenna;
g) through operation of the at least one processor included in the detection system, causing a further communication to be sent to the monitoring system responsive at least in part to the data representative of the reference measurement and the data representative of the at least one further measurement;
h) through operation of the at least on processor included in the monitoring system, causing a further output through the at least one output device, indicative of a detection problem with the detection system responsive at least in part to the further communication received from the detection system in (g).

17. The method according to claim 11, further comprising:
e) detecting a further mobile phone signal through operation of the detection system in (a);
f) through operation of the at least one processor included in the detection system, detecting a secondary radio frequency (RF) signal transmitted from at least one of a token and the mobile phone in the location adjacent to the detection system from which the mobile phone signal is detected in (e);
g) through operation of the at least one processor included in the detection system, responsive at least in part to the detection of the secondary RF signal in (e), forgoing communicating a detection of the mobile phone signal in (e) to the monitoring system.

18. The method according to claim 17, wherein in (f) the secondary RF signal is transmitted from a token that includes at least one of a badge, card, and RFID.

19. The method according to claim 11, wherein the detection system in (a) includes a battery operative to power the at least one processor included in the detection system, further comprising:
e) prior to (a) through operation of the at least one processor included in the detection system, placing the detection system into a state which provides no electrical power from the battery to the at least one processor;
f) prior to (b) through operation of the detection system responsive at least in part to (a), placing the detection system into a further state that is operative to provide power from the battery to the at least one processor.

20. The method according to claim 11, wherein in (a) the detection system includes a directional antenna adapted to detect the mobile phone signals transmitted on a first side of the antenna at a first distance from the antenna, which mobile phone signal would not be detectable when transmitted on a second side of the antenna at the same distance from the antenna.

21. A system comprising:
at least one detection system operative to detect mobile phone signals transmitted in a location adjacent the at least one detection system, wherein the at least one detection system includes at least one processor;
at least one output device spaced apart from the at least one detection system, wherein the at least one output device is operative to emit at least one color of light;
wherein the at least one processor of the detection system is responsive at least in part to a detection of a mobile phone signal transmitted from the location adjacent the at least one detection system to cause the at least one output device to emit the at least one color of light.

22. The system according to claim 21, further comprising a vehicle, wherein the vehicle includes a seat of an operator of the vehicle, wherein the at least one detection system is mounted in the vehicle, wherein the location adjacent the detection system includes the seat of the operator, wherein the at least one output device is mounted so as to emit light so that a person at least one of inside and outside of the vehicle can view the light emitted from the at least one output device, wherein the at least one output device is at least one of in wired and in wireless communication with the at least one detection system, wherein the vehicle includes at least one of a land vehicle, a water craft, an automobile, a truck, a train, a bus, a trolley, and a ship.

23. The system according to claim 22, wherein the vehicle includes a rear end, wherein the rear end includes a license plate, wherein the at least one output device is mounted so as to emit light from the vehicle such that a person positioned outside the vehicle in view of the license plate can view the emitted light from the at least one output device.

24. The system according to claim 22, wherein the at least one detection system includes a plurality of spaced apart directional antennas orientated to detect mobile phone signals in different respective locations including a first location adjacent the seat of the operator of the vehicle and at least one second location that is farther from the first location than the first antenna, wherein the at least one processor is responsive to different respective signals from each respective antenna to determine when a detected mobile phone signal is more likely being transmitted from the first location adjacent the seat of the operator of the vehicle than the at least one second location, wherein the at least one detection system is operative to cause the at least one display device to emit light responsive at least in part to the determination that the detected mobile phone signal is more likely being transmitted from the first location adjacent the seat of the operator of the vehicle than the second location.
